(19) United States
(12) Patent Application Publication
(10) Pub. No.: US 2026/0093988 A1
(43) Pub. Date: Apr. 2, 2026

(54) ATTENTION MECHANISM ADJUSTMENT METHOD BASED ON ATTENTION SCORE AND COMPUTING DEVICE USING THE SAME

(71) Applicant: Industrial Technology Research Institute, Hsinchu (TW)

(72) Inventors: Yao-Hua Chen, Changhua County (TW); Po-Hung Lin, Hsinchu City (TW); Chih-Tsun Huang, Hsinchu City (TW)

(73) Assignee: Industrial Technology Research Institute, Hsinchu (TW)

(21) Appl. No.: 18/961,430

(22) Filed: Nov. 26, 2024

(30) Foreign Application Priority Data
Sep. 27, 2024 (TW) 113137074

(51) Int. Cl. G06N 3/082; G06N 3/045

(52) U.S. Cl. CPC G06N 3/082; G06N 3/045

(57) ABSTRACT

An attention mechanism adjustment method based on attention scores, applicable to Transformer models, is provided. The method includes: for the current Transformer block of the Transformer model, obtaining query matrix, key matrix, and value matrix based on the input sequence; using the self-attention module to generate multiple attention score matrices corresponding to multiple attention heads; before executing the softmax function, performing cross-head column-wise aggregation operation on the attention score matrices to obtain a token importance vector; comparing importance scores with the trained importance score threshold to determine if pruning is needed; executing pruning operations on target tokens that need pruning to obtain pruned attention score matrices; performing softmax function operations on the pruned attention score matrices to obtain a pruned attention probability matrix, where the probability values of the pruned tokens are zero.

### CROSS-REFERENCE TO RELATED APPLICATION

This application claims the priority benefit of Taiwan application serial no. 113137074, filed on Sep. 27, 2024. The entirety of the above-mentioned patent application is hereby incorporated by reference herein and made a part of this specification.

### BACKGROUND

### Technical Field

The present disclosure relates to optimization techniques for transformer architecture models. The present disclosure concerns an attention mechanism adjustment method based on attention scores, applicable to transformer architecture models.

### Description of Related Art

In recent years, large language models based on transformer architectures have achieved great success in the field of natural language processing (NLP). However, the increasing scale of these models has led to a significant increase in computational resource consumption, facing challenges of efficiency and latency in practical applications. To address these issues, researchers have proposed various model optimization techniques, among which model pruning is an effective method.

Traditional attention mechanism pruning methods typically judge the importance of tokens based on attention probabilities. However, when combined with kernel fusion techniques, this approach encounters buffer overhead problems, limiting the acceleration effect and memory efficiency of the model, affecting the model's stability and performance. In particular, as the size of the model and the input data to be processed increases, the resulting system latency problems and computational resource consumption issues become more pronounced.

### SUMMARY

The purpose of this disclosure is to provide an attention mechanism adjustment method based on attention scores and a computing device using said method, to solve the aforementioned problems in the existing technology. The method of this disclosure can effectively reduce computational resource consumption, improve model inference speed, while maintaining model accuracy.

One or more embodiments of this disclosure provide an attention mechanism adjustment method based on attention scores, applicable to a transformer model. The method includes: For a current transformer block of the transformer model, obtaining a query matrix, a key matrix and a value matrix corresponding to a received input sequence, wherein the input sequence comprises a plurality of tokens; generating a plurality of attention score matrices corresponding to the input sequence based on the query matrix and the key matrix, wherein the attention score matrices respectively correspond to a plurality of attention heads; before executing a softmax function operation, performing a cross-head column-wise aggregation operation on the attention score matrices to obtain a token importance vector corresponding to the input sequence, wherein a plurality of elements of the token importance vector respectively represent a plurality of importance scores corresponding to the tokens; determining whether each token of the input sequence needs to be pruned through the importance score of each element in the token importance vector and a trained importance score threshold; in response to determining that one or more target tokens need to be pruned, changing the attention score matrices into a plurality of pruned attention score matrices by performing a pruning operation on the one or more target tokens; and performing the softmax function operation on the pruned attention score matrices to obtain a pruned attention probability matrix, wherein one or more probability values corresponding to the pruned one or more target tokens in the pruned attention probability matrix are zero, so as to optimize the attention mechanism of the transformer model, reduce invalid operations in subsequent calculations, and thereby improve calculation efficiency and inference speed of the transformer model.

One or more embodiments of this disclosure provide a computing device, adapted for executing a transformer model that adjusts attention mechanism based on attention scores, the computing device comprising: a processor; a memory, coupled to the processor; and a storage device, coupled to the processor, the storage device storing a plurality of program code modules. The processor is configured to execute the program code modules to: For a current transformer block of the transformer model: obtain, via a query-key-value (QKV) generation module, a query matrix, a key matrix and a value matrix corresponding to a received input sequence, wherein the input sequence comprises a plurality of tokens; generate, via an attention calculation module, a plurality of attention score matrices corresponding to the input sequence based on the query matrix and the key matrix, wherein the attention score matrices respectively correspond to a plurality of attention heads; before executing a softmax function operation, perform, via a pruning module, a cross-head column-wise aggregation operation on the attention score matrices to obtain a token importance vector corresponding to the input sequence, wherein a plurality of elements of the token importance vector respectively represent a plurality of importance scores corresponding to the tokens; determine, via the pruning module, whether each token of the input sequence needs to be pruned through the importance score of each element in the token importance vector and a trained importance score threshold; in response to determining that one or more target tokens need to be pruned, change, via the pruning module, the attention score matrices into a plurality of pruned attention score matrices by performing a pruning operation on the one or more target tokens; and perform the softmax function operation on the pruned attention score matrices to obtain a pruned attention probability matrix, wherein one or more probability values corresponding to the pruned one or more target tokens in the pruned attention probability matrix are zero, so as to optimize the attention mechanism of the transformer model, reduce invalid operations in subsequent calculations, and thereby improve calculation efficiency and inference speed of the transformer model.

Based on the above, the attention mechanism adjustment method and computing device provided by one or more embodiments of this disclosure, by using attention score matrices to calculate token importance, avoid the buffer overhead problem when combined with kernel fusion techniques, improving the overall performance of the model. By comparing importance scores with thresholds, it precisely identifies and prunes unimportant tokens, significantly reducing computational complexity and memory usage while maintaining model accuracy. This method directly prunes attention score matrices and applies the softmax function to obtain pruned attention weight matrices, reducing invalid operations and improving the computational efficiency and inference speed of transformer models, particularly suitable for applying large language models in resource-constrained environments.

To make the aforementioned more comprehensible, several embodiments accompanied with drawings are described in detail as follows.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1A is a block diagram of a computing device according to an embodiment of the present disclosure.

FIG. 1B is a schematic diagram of program code modules stored in the storage device according to an embodiment of the present disclosure.

FIG. 2 is a flow chart of an attention mechanism adjustment method according to an embodiment of the present disclosure.

FIG. 3 is a schematic diagram of a transformer model according to an embodiment of the present disclosure.

FIG. 4 is a schematic diagram of the architecture of a transformer model according to an embodiment of the present disclosure.

FIG. 5A is a schematic diagram of a self-attention layer of a traditional transformer model.

FIG. 5B is a schematic diagram of a self-attention layer of a transformer model according to an embodiment of the present disclosure.

FIG. 6A is a schematic diagram of attention score matrices and token importance vector according to an embodiment of the present disclosure.

FIG. 6B is a schematic diagram of pruning operation according to an embodiment of the present disclosure.

FIG. 7 is a schematic diagram illustrating the application of differentiable masks in the model training stage according to an embodiment of the present disclosure.

FIG. 8 is a schematic diagram illustrating the application of binary masks in the model retraining stage according to an embodiment of the present disclosure.

FIG. 9A is a schematic diagram illustrating the application of range scaling strategy to generate differentiable masks according to an embodiment of the present disclosure.

FIG. 9B is a schematic diagram of normalized performance comparison according to an embodiment of the present disclosure.

FIG. 10 is a schematic diagram illustrating the application of an inverse scaling function to generate binary masks according to an embodiment of the present disclosure.

FIG. 11 is a schematic diagram comparing the consumed buffer sizes corresponding to different pruning methods according to an embodiment of the present disclosure.

FIG. 12 is a schematic diagram comparing FLOPs, data access volume, and latency between traditional methods and the attention mechanism adjustment method provided by this disclosure.

### DESCRIPTION OF THE EMBODIMENTS

Reference will now be made in detail to the embodiments of the present disclosure, examples of which are illustrated in the accompanying drawings. Wherever possible, the same reference numbers are used in the drawings and the description to refer to the same or like parts.

It should be understood that the terms “system” and “network” are often used interchangeably in this disclosure. The term “and/or” used in this disclosure is only for describing the association relationship of related objects, which means that there may be four relationships, for example, A and/or B may mean four situations: A, B, A and B, A or B. In addition, the character “/” in this disclosure generally indicates that the associated objects are in an “or” relationship.

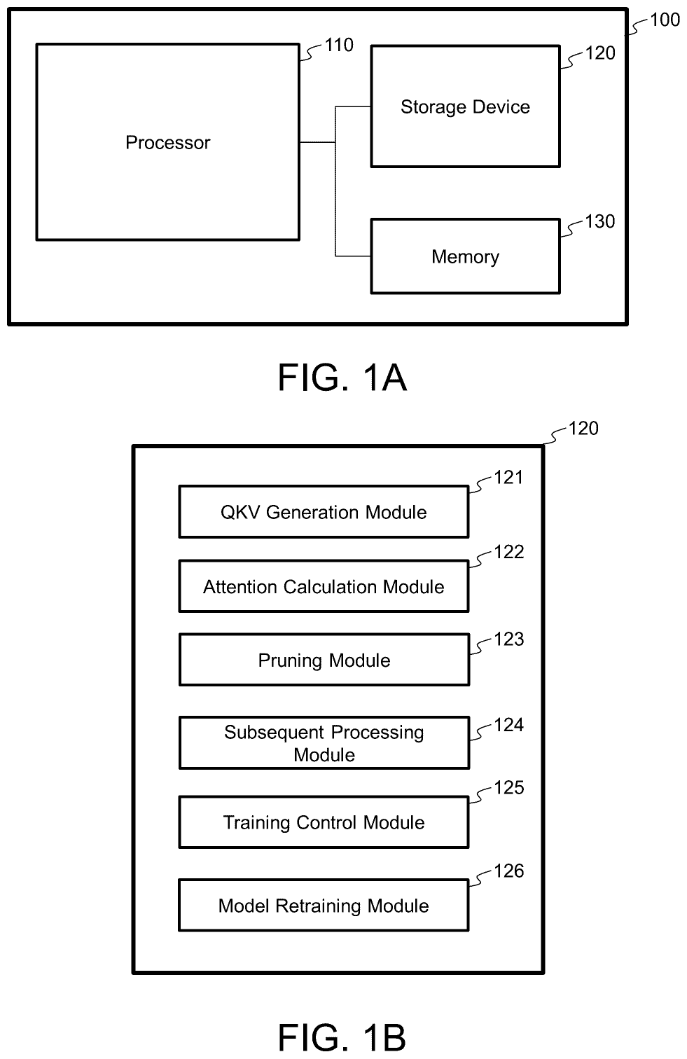

FIG. 1A is a block diagram of a computing device according to an embodiment of the present disclosure. In one embodiment, as shown in FIG. 1A, the present disclosure provides a computing device 100 for implementing an attention mechanism adjustment method based on attention scores. The computing device 100 includes a processor 110, a storage device 120, and a memory 130.

The processor 110 may be a central processing unit (CPU), a graphics processing unit (GPU), a digital signal processor (DSP), an application-specific integrated circuit (ASIC), a field-programmable gate array (FPGA), or other suitable computing units for executing the method of the present disclosure. The processor 110 is responsible for executing program instructions or program code modules stored in the storage device 120 or memory 130 to implement the attention mechanism adjustment method of the present disclosure.

The storage device 120 may be a hard disk drive, a solid-state drive, flash memory, or other non-volatile storage media. The storage device 120 is used to store parameters of a transformer model, training data, intermediate calculation results, and program code modules and other data required to implement the method of the present disclosure. In addition, the storage device 120 could also store operating systems and applications.

FIG. 1B is a schematic diagram of program code modules stored in the storage device according to an embodiment of the present disclosure. In one embodiment, as shown in FIG. 1B, the storage device 120 of the present disclosure stores a plurality of program code modules 121˜126, which collectively implement the attention mechanism adjustment method based on attention scores. The main program code modules in the storage device 120 include:

QKV generation module 121: This module is responsible for generating query matrix (Q), key matrix (K), and value matrix (V) based on the input sequence. Specifically, the QKV generation module 121 contains three independent linear transformation layers, used to generate Q, K, and V matrices respectively.

Attention calculation module 122: This module performs the core computation of the self-attention mechanism. It first calculates the attention score matrices by multiplying the query matrix (Q) with the transpose of the key matrix (K), and then performs a scaling operation.

Pruning module 123: This module is responsible for performing token pruning operations based on attention scores. It first performs column-wise summation on the attention score matrices to obtain a token importance vector. Then, it compares the importance score of each token with the trained importance score threshold to decide whether to prune that token. For tokens that need to be pruned, the pruning module 123 sets their corresponding attention scores to zero or removes them from the matrix.

Subsequent processing module 124: This module is responsible for subsequent operations after pruning, including applying the softmax function to the pruned attention score matrices to obtain the pruned attention probability matrices. In addition, it is responsible for executing the remaining operations of the multi-head attention mechanism, calculations of the feed-forward neural network layer, and adding residual connections and layer normalization (e.g., add and normalization layers) operations.

Training control module 125: This module is responsible for managing the model training process, especially the training of threshold parameters. It implements the generation and application of differentiable masks, calculates downstream task losses and threshold losses, and updates the model parameters and threshold parameters of the transformer model based on the total loss. This training control module 125 also includes the application of a scaling function to improve the stability and efficiency of training.

Model retraining module 126: This implements the model retraining process after determining the final threshold parameters (trained importance score thresholds). It uses fixed trained importance score thresholds, applies binary masks for actual pruning, and updates the model's weight parameters to adapt to the pruned network structure. This model retraining module 126 also includes the application of a further scaling function (also called inverse scaling function) to improve the efficiency of pruning operations.

It should be noted that in one embodiment, when the model retraining stage is completed, the processor 110 can execute an inference module to handle the operation of the inference stage. In this inference stage, it is no longer necessary to calculate loss values for updating model weight parameters. However, in the inference stage, pruning operations are still performed in the self-attention layer of each transformer block to improve work efficiency.

The operation flow of these program code modules is, for example: The QKV generation module 121 first processes the input sequence to generate Q, K, V matrices; the attention calculation module 122 uses these matrices to calculate attention score matrices; the pruning module 123 evaluates token importance and performs pruning operations; the subsequent processing module 124 completes the remaining attention mechanism calculations and processing of other network layers; during the training stage, the training control module 125 manages the entire training process, including learning of threshold parameters; after training is completed, the model retraining module 126 uses the finally determined threshold parameters to fine-tune other weight parameters of the model.

Please refer back to FIG. 1A, the memory 130 could be dynamic random access memory (DRAM), static random access memory (SRAM), or other types of volatile or non-volatile memory. The memory 130 is used to store data and instructions currently being processed, including but not limited to input sequences, attention score matrices, token importance vectors, trained importance score thresholds, pruned attention score matrices, pruned attention probability matrices, etc. The high-speed access characteristics of the memory 130 allow the processor 110 to quickly read and write data, thereby improving computational efficiency.

In the operation process of the computing device 100, the processor 110 reads instructions and data from the storage device 120 or memory 130, and executes various steps of the attention mechanism adjustment method. These steps include but are not limited to: generating query matrices, key matrices, and value matrices; calculating attention score matrices; performing token importance evaluation; executing pruning operations; and applying softmax functions, etc. The processor 110 stores intermediate results and final outputs in the memory 130, and writes data that needs to be preserved long-term to the storage device 120.

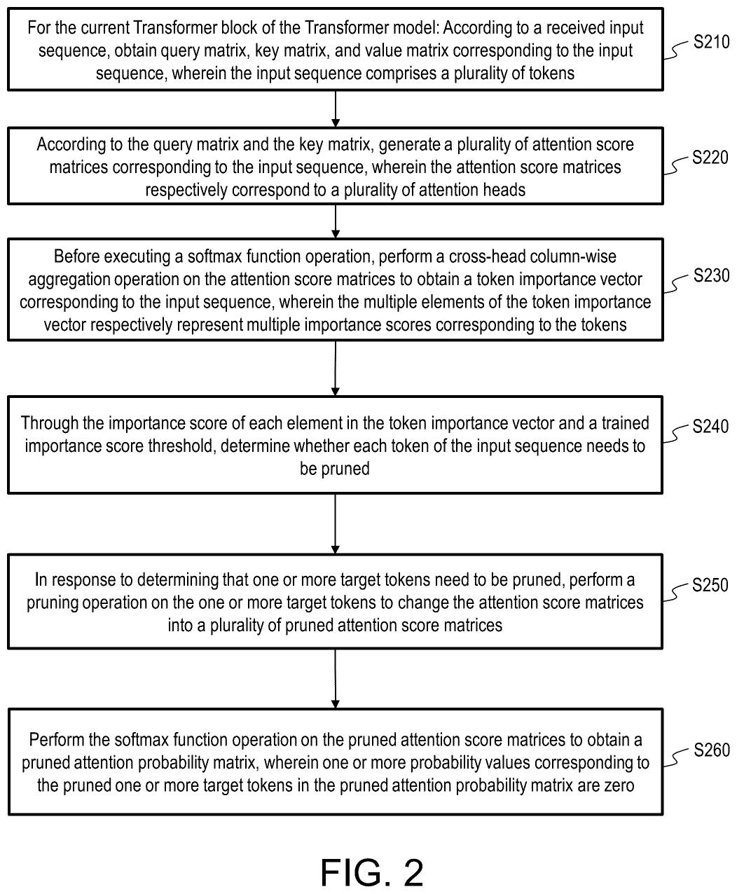

FIG. 2 is a flow chart of an attention mechanism adjustment method according to an embodiment of the present disclosure.

In an embodiment of the present disclosure, as shown in FIG. 2, an attention mechanism adjustment method for a transformer model is provided. The method includes the following steps (S210-S260):

Step S210: For a current transformer block of the transformer model, obtain a query matrix, a key matrix and a value matrix corresponding to a received input sequence, wherein the input sequence comprises a plurality of tokens. Wherein, query matrix: used to represent the features of the currently processed token; key matrix: used to calculate relevance with the query matrix; value matrix: used to generate the final attention output. For example, in one embodiment, for the current transformer block of the transformer model, receive an input sequence “I love my family”. Assuming the model uses word-level tokenization, the input sequence contains 4 tokens: [“I”, “love”, “my”, “family”]. Assuming the attention head or key matrix dimension is 8, the QKV generation module generates query matrix (Q), key matrix (K) and value matrix (V) through linear transformation layers respectively, each matrix with a dimension of 4×8.

Step S220: Generate a plurality of attention score matrices corresponding to the input sequence based on the query matrix and the key matrix, wherein the attention score matrices respectively correspond to a plurality of attention heads. This step typically involves matrix multiplication operations, such as

$$S = \frac{{QK}^{T}}{\sqrt{{d}_{k}}} ,$$

where Q represents the query matrix, obtained by linear transformation of elements in the input sequence; K represents the key matrix, also obtained by linear transformation of the input sequence; K^{T} is the transpose of the key matrix; dₖ is the dimension of the attention head or key matrix (in the above example, it is 8); \sqrt{dₖ} is used for scaling, which is to avoid the value being too large during inner product when dₖ is large, leading to gradient vanishing or exploding. The core of this formula is to obtain attention scores through similarity calculation between query matrix and key matrix, then these scores will be used to calculate weights, further applied to the subsequent value matrix (V). Continuing with the example of the input sequence above, assume the calculation result is as follows:

S = [
[5, 50, 10, 35],
[15, 10, 25, 50],
[15, 10, 25, 50],
[15, 50, 15, 20]
].

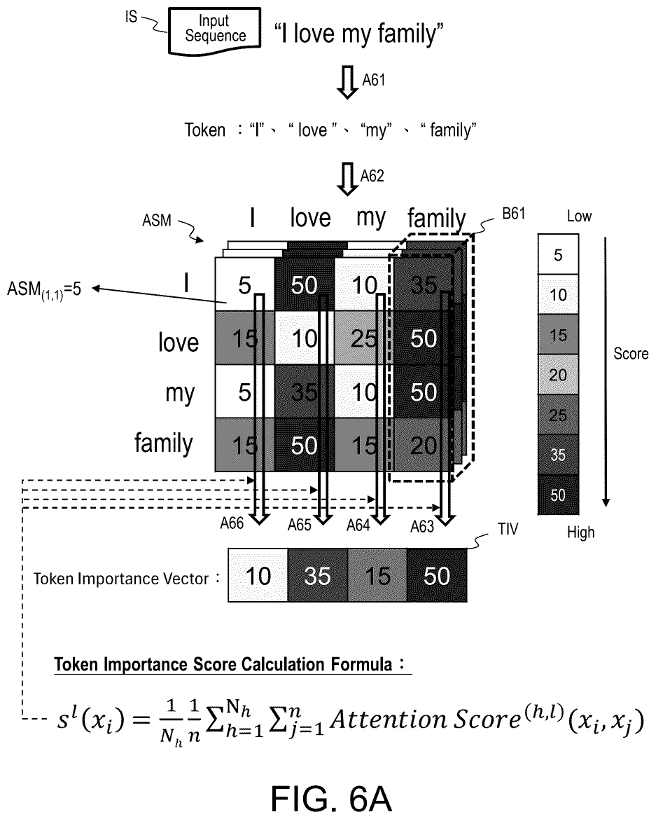

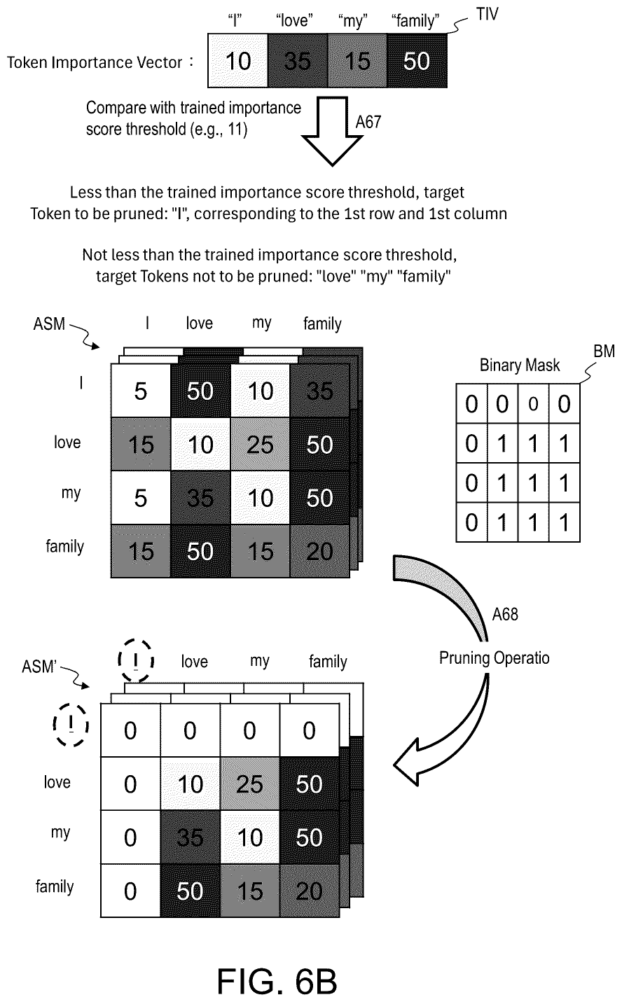

Step S230: Before executing a softmax function operation, perform a cross-head column-wise aggregation operation on the attention score matrices (details will be explained later with FIG. 6A) to obtain a token importance vector corresponding to the input sequence, wherein a plurality of elements of the token importance vector respectively represent a plurality of importance scores corresponding to the tokens. For example, perform column-wise averaging on eight 4×4 attention score matrices to obtain a 4-dimensional token importance vector. For example: the token importance vector corresponding to 4 tokens [“I”, “love”, “my”, “family”] is [10, 35, 15, 50], indicating that “family” has the highest importance, followed by “love”, then “my”, and “I” is the lowest.

Step S240: Determine whether each token of the input sequence needs to be pruned through the importance score of each element in the token importance vector and a trained importance score threshold. Assume the trained importance score threshold is 11. After comparing each element in the token importance vector with the trained importance score threshold:

For example, “I”: 10<11, needs pruning; “love”: 35>11, retain; “my”: 15>11, retain; “family”: 50>11, retain. That is, it is determined that token “I” needs to be pruned.

In an embodiment of the present disclosure, the step of determining whether the corresponding token needs to be pruned by comparing the importance score of each element in the token importance vector with the trained importance score threshold includes: using the trained importance score threshold to generate a binary mask, the binary mask being used for the pruning operation. The generation process of the binary mask includes: in response to determining that the importance score of a first target element of each token importance vector is greater than the trained importance score threshold, setting a value corresponding to the first target element in the binary mask to 1; in response to determining that the importance score of a second target element of each token importance vector is not greater than the trained importance score threshold, setting a value corresponding to the second target element in the binary mask to 0. The step of performing the pruning operation includes: applying the binary mask to each attention score matrix to obtain the pruned attention score matrix.

Step S250: In response to determining that one or more target tokens need to be pruned, change the attention score matrices into a plurality of pruned attention score matrices by performing a pruning operation on the one or more target tokens. For example, perform the pruning operation via the pruning module 123 to set the row and column corresponding to “I” in the attention score matrix S to zero. For example, the pruned attention score matrix is:

S’ = [
[0, 0, 0, 0],
[0, 10, 25, 50],
[0, 10, 25, 50],
[0, 50, 15, 20]
].

Step S260: Perform the softmax function operation on the pruned attention score matrices to obtain a pruned attention probability matrix, wherein one or more probability values corresponding to the pruned one or more target tokens in the pruned attention probability matrix are zero. For example, the pruned attention weight matrix

= [
[0, 0, 0, 0],
[0, 0.2, 0.3, 0.5],
[0, 0.2, 0.3, 0.5],
[0, 0.5, 0.2, 0.3]
].

That is, the row and column corresponding to the pruned token (“I”) will be all zero, while the attention distribution among other tokens will be recalculated and normalized.

In this way, by pruning unimportant tokens, the computation amount and memory usage are effectively reduced while maintaining the model's focus on key information. This method is particularly suitable for processing long sequence inputs and can significantly improve the inference efficiency of large language models.

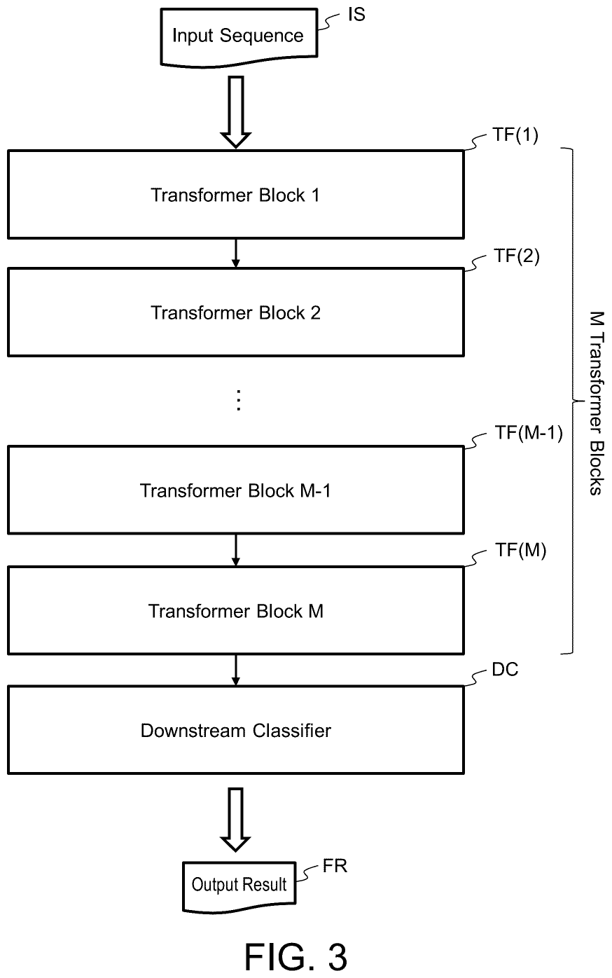

FIG. 3 is a schematic diagram of a transformer model according to an embodiment of the present disclosure. In an embodiment of the present disclosure, as shown in FIG. 3, a transformer model architecture based on attention scores is provided. The model architecture includes several key components. The transformer model is a neural network architecture based on self-attention mechanism, widely used in various sequence processing tasks.

The following briefly explains the components of the transformer model and their functions:

Input sequence (IS): This is the starting point of the model, representing the original data to be processed. For example, in natural language processing tasks, the input sequence might be a sentence or a paragraph of text. The input sequence could be divided into multiple tokens, each token could contain a word.

Transformer block: The model contains M transformer blocks TF(1), TF(2), . . . , TF(M). Each transformer block performs the same operations but has its own set of parameters. The main functions of the transformer block include: (a) Multi-Head Attention, in each transformer block, Multi-Head Attention: a mechanism that allows the model to simultaneously focus on different parts of the input, and uses the pruning method based on attention scores proposed in this disclosure. (b) Feed-Forward Neural Network (FFN), for further processing of the output of the multi-head attention mechanism; (c) Add & Normalization layer, used to help stabilize the training process and improve information flow.

Downstream Classifier DC: This is the last layer of the model, responsible for converting the output of the transformer into results for specific tasks. For example, in a sentiment analysis task, the downstream classifier can analyze the input sequence to output positive or negative sentiment labels (output results). For instance, in a text generation task, the downstream classifier can output the content corresponding to the input sequence. The Downstream Classifier DC could be implemented using one or more of the following mechanisms: Fully Connected Layer, Convolutional Neural Network (CNN), Recurrent Neural Network (RNN), Pooling Layer, Multi-Layer Perceptron (MLP), etc.

Output result (FR): This is the final output of the model, representing the processing result of the input sequence.

The more general operation flow of the transformer is as follows, the input sequence IS enters the first transformer block TF(1); each transformer block TF(i) processes the output from the previous block, performs attention mechanism (including pruning operations) and feed-forward neural network calculations, i=1˜M; after processing by M transformer blocks, the data flows to the downstream classifier DC; the downstream classifier DC generates the final output result FR.

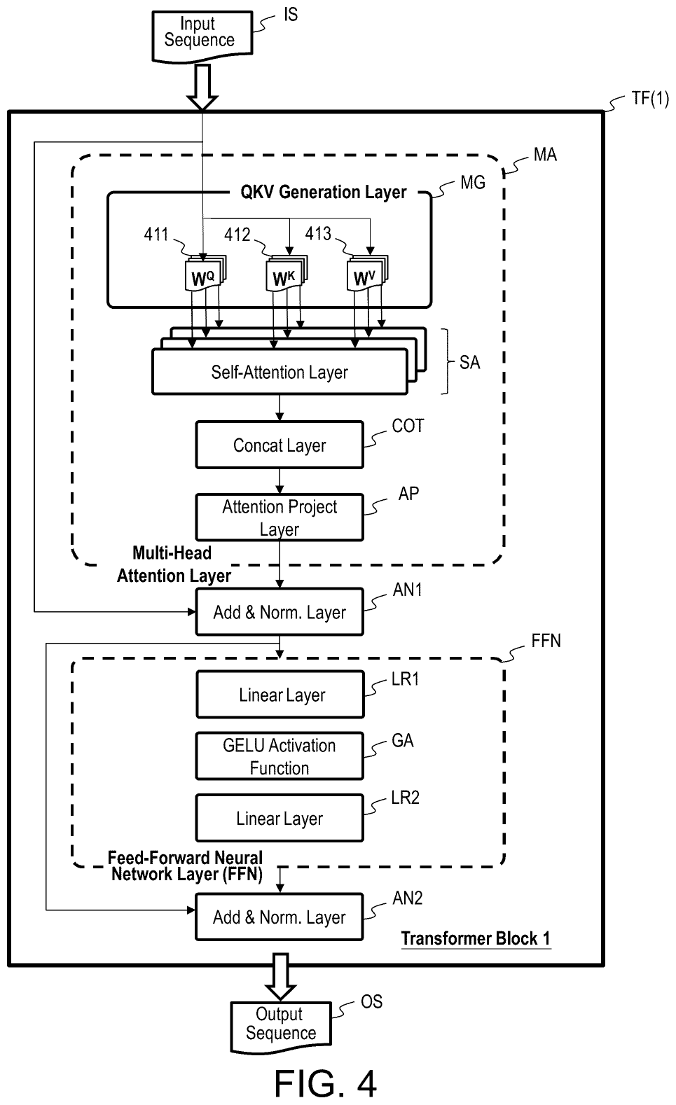

FIG. 4 is a schematic diagram of the architecture of a transformer model according to an embodiment of the present disclosure. As shown in FIG. 4, taking transformer block 1 (TF(1)) as an example, each transformer block includes the following main components:

Multi-head attention layer MA: This layer includes QKV generation layer MG, self-attention layer SA, concatenation layer COT and attention projection layer AP. Multi-Head Attention: divides the attention mechanism into multiple “heads”, each head independently calculates attention, and then combines the results.

More specifically, (a) QKV generation layer (MG): includes three parallel weight matrices W^{Q} 411, weight matrix W^{K} 412 and weight matrix W^{V} 413, used to generate query matrix (Q), key matrix (K) and value matrix (V) corresponding to the input sequence IS respectively; (b) self-attention layer (SA): uses the generated Q, K, V matrices to calculate attention score matrices and perform subsequent attention mechanism calculations. Attention score matrix: a matrix representing the degree of association between different positions of tokens in the input sequence;

(c) concatenation layer (COT): connects the output results of multiple attention heads together. (d) attention projection layer AP: performs linear transformation on the concatenated result to produce the final output of the multi-head attention mechanism, which will be input to the first add and normalization layer AN1.

First add and normalization layer AN1: Performs residual connection and layer normalization on the output of the multi-head attention layer MA and the original input. Residual connection: directly adds the input of the layer to its output, which helps alleviate the training difficulties of deep networks. In one embodiment, layer normalization could be implemented by including the following steps:

(1) Calculate mean. Calculate the mean across the feature dimension for each sample. Assuming the input tensor is x, with dimensions [batch_size, sequence_length, feature_dim], then:

$$μ = ( 1 / feature\_dim ) * Σ ( x\_i ) .$$

(2) Calculate variance. Similarly calculate the variance across the feature dimension: σ\hat{ }2=(1/feature_dim)*Σ((x_i−μ)\hat{ }2).

(3) Normalize. Normalize the input using the calculated mean and variance: x_norm=(x−μ)/sqrt(σ²+ε). Where ε is a small constant for numerical stability.

(4) Scale and shift. Introduce learnable parameters γ (scale factor) and β (shift factor): y=γ*x_norm+β.

Feed-forward neural network layer FFN: Includes two linear transformation layers LR1, LR2 and a GELU activation function layer GA. Where, first linear transformation layer LR1: performs linear transformation on the input; GELU activation function layer GA: applies the GELU activation function to the result of the linear transformation of the first linear transformation layer LR1; second linear transformation layer LR2: performs linear transformation again on the result after applying the GELU activation function. GELU activation function, also known as Gaussian Error Linear Unit, is a non-linear activation function commonly used in neural networks.

Second add and normalization layer AN2: Performs residual connection and layer normalization on the output of the feed-forward neural network layer FFN and its input, to output an output sequence OS.

In one embodiment, the general operation flow of each transformer block is as follows (taking transformer block 1 as an example): transformer block 1 TF(1) receives the input sequence IS; passes the input sequence IS into transformer block 1 TF(1) for processing; performs multi-head attention mechanism calculations within transformer block 1 TF(1); executes feed-forward neural network layer calculations via FFN; outputs the processed output sequence OS.

In this embodiment, the pruning method based on attention scores is mainly applied to the self-attention layer in the multi-head attention layer MA, thereby changing the output to affect the computational burden of subsequent layers.

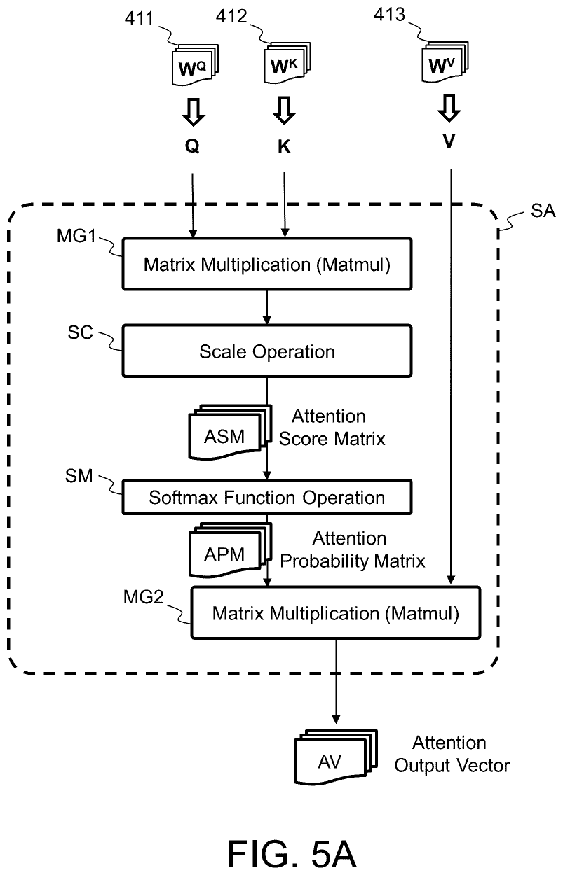

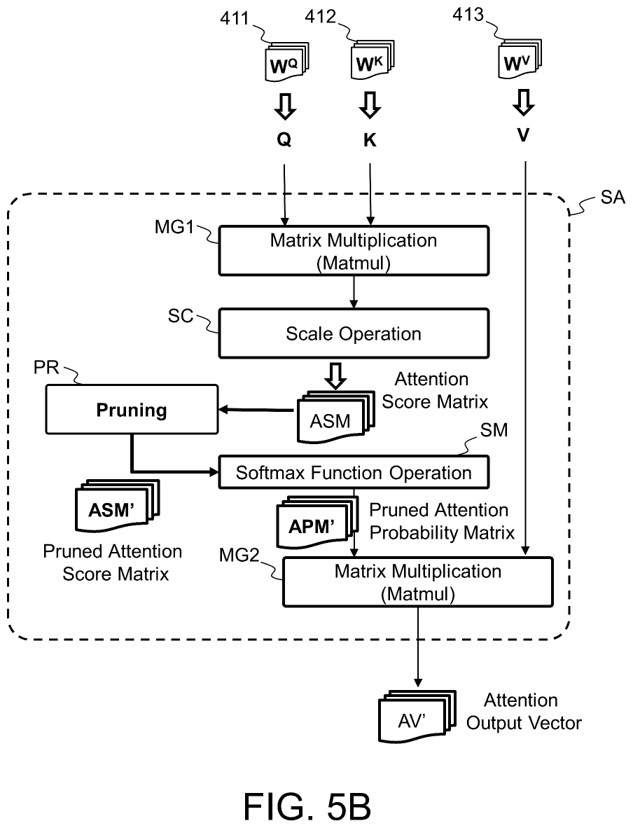

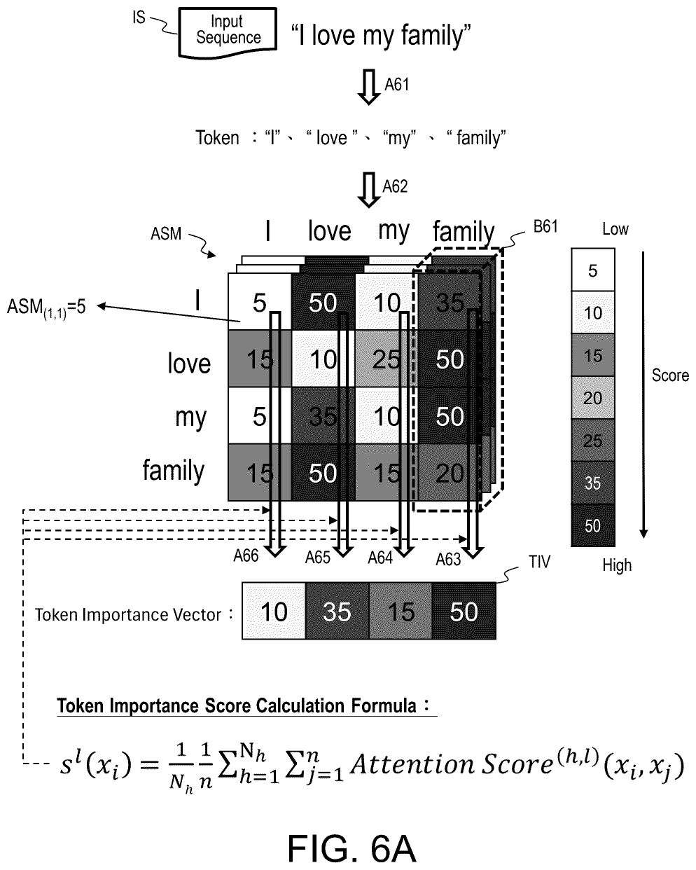

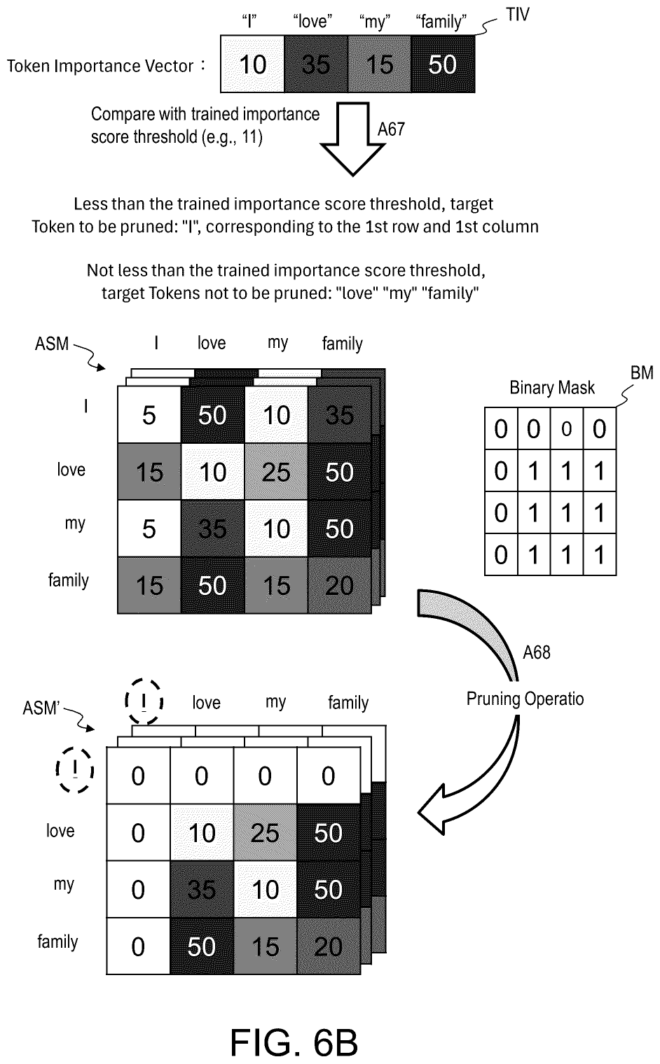

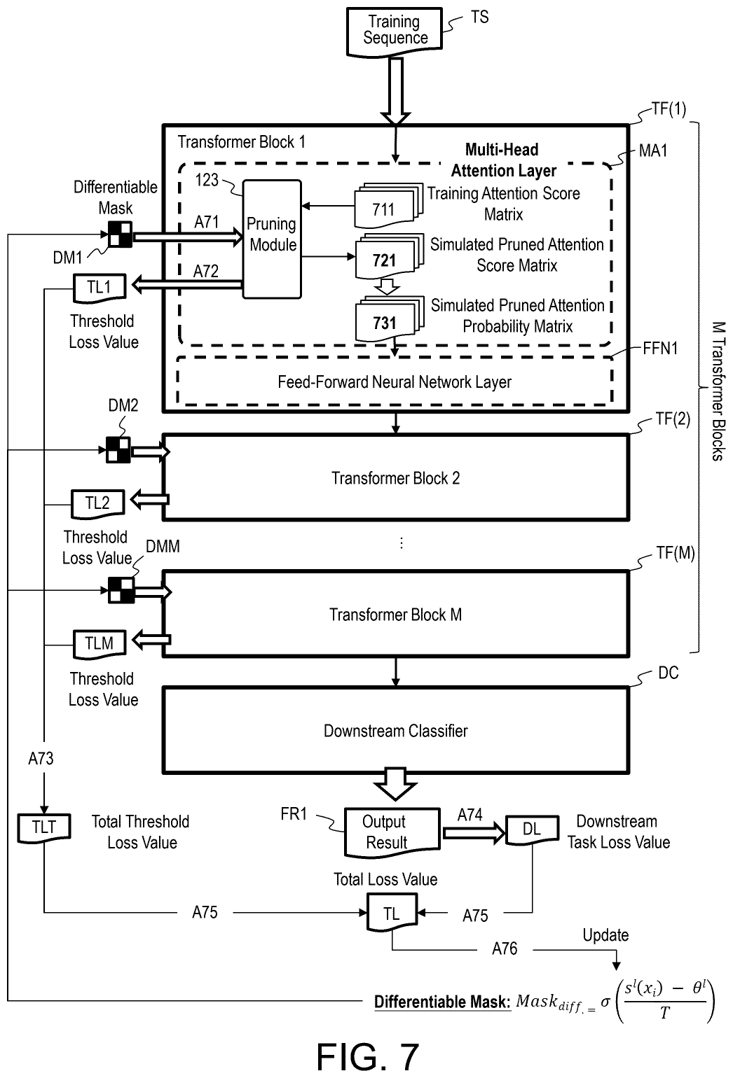

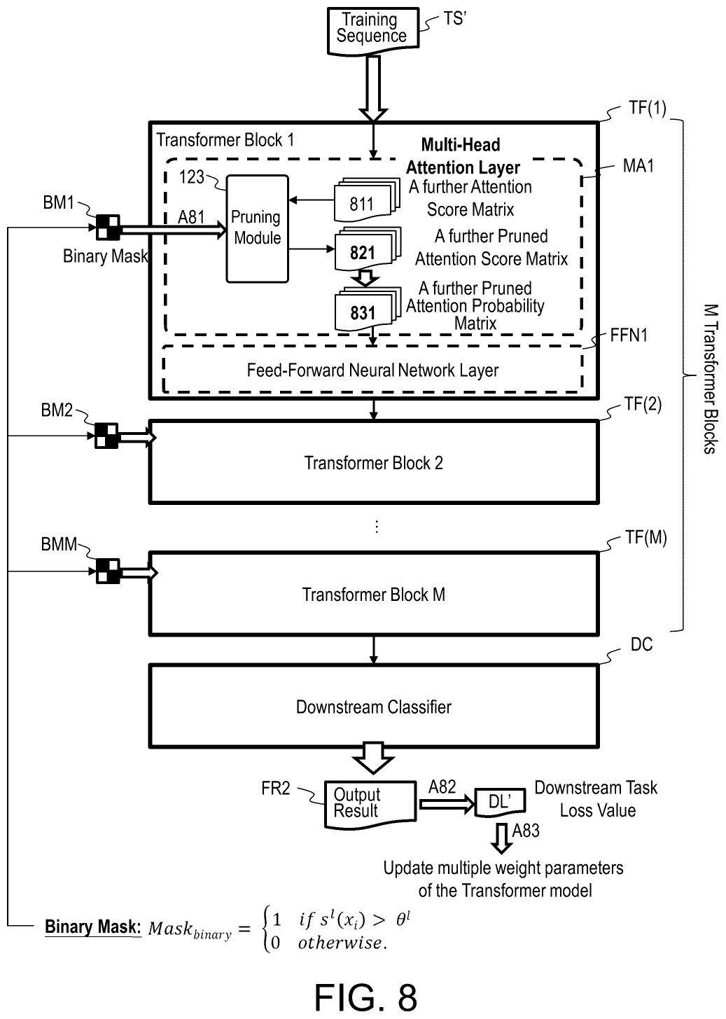

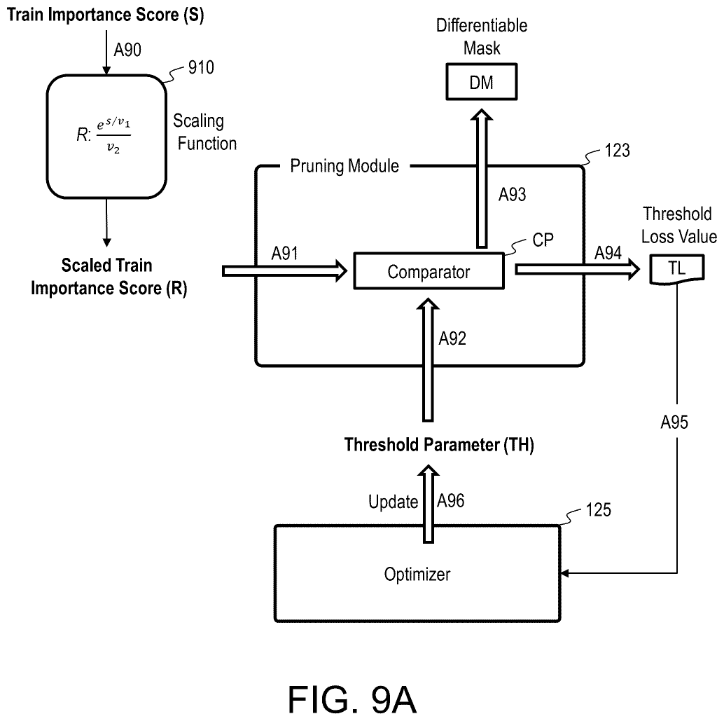

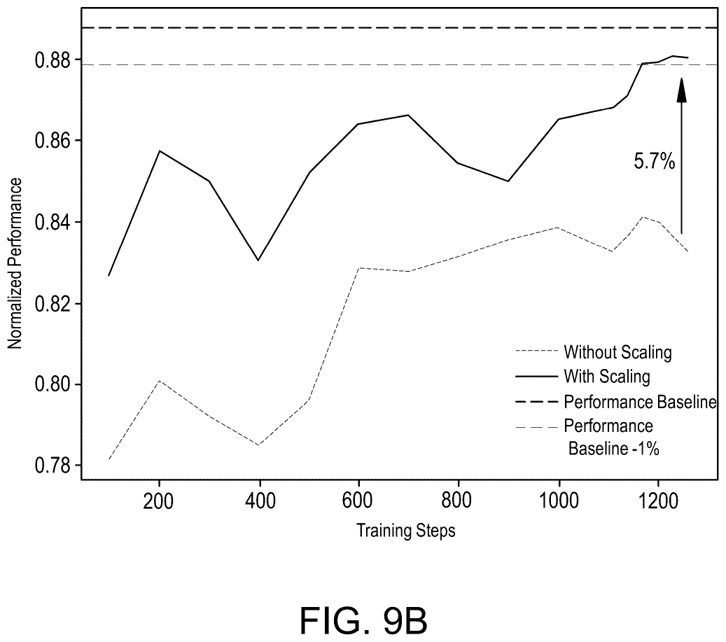

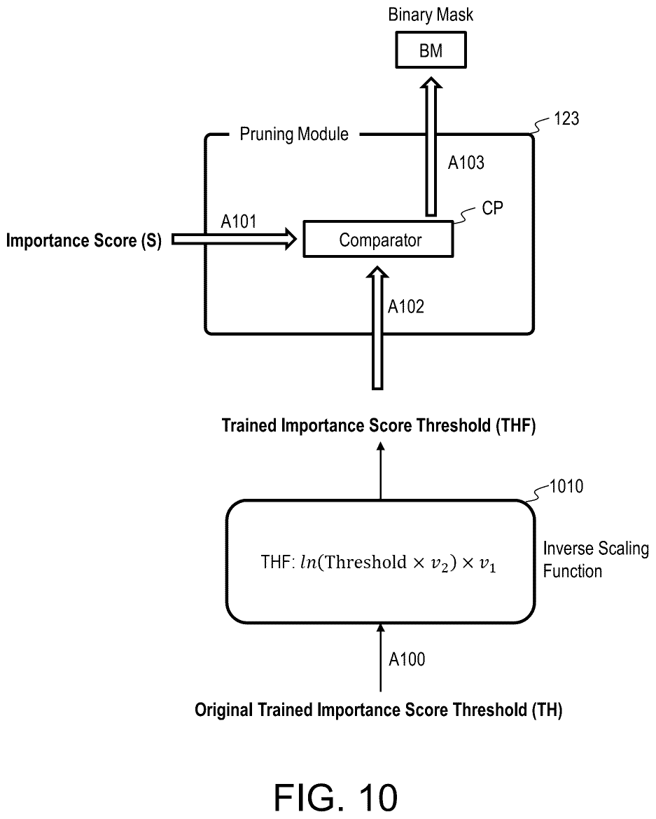

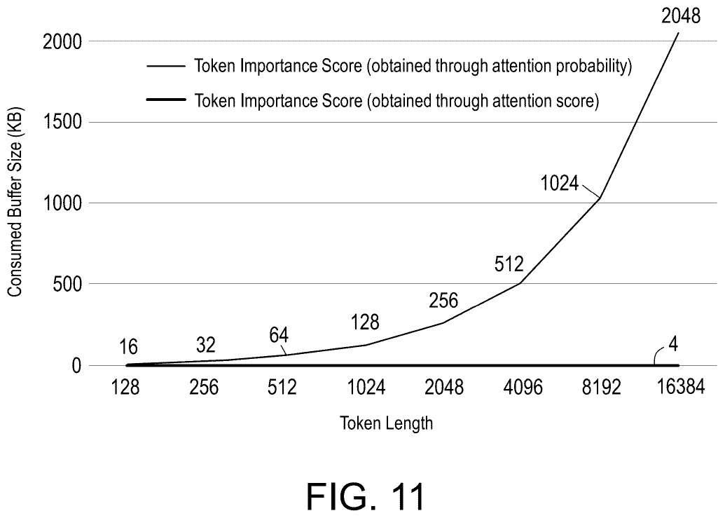

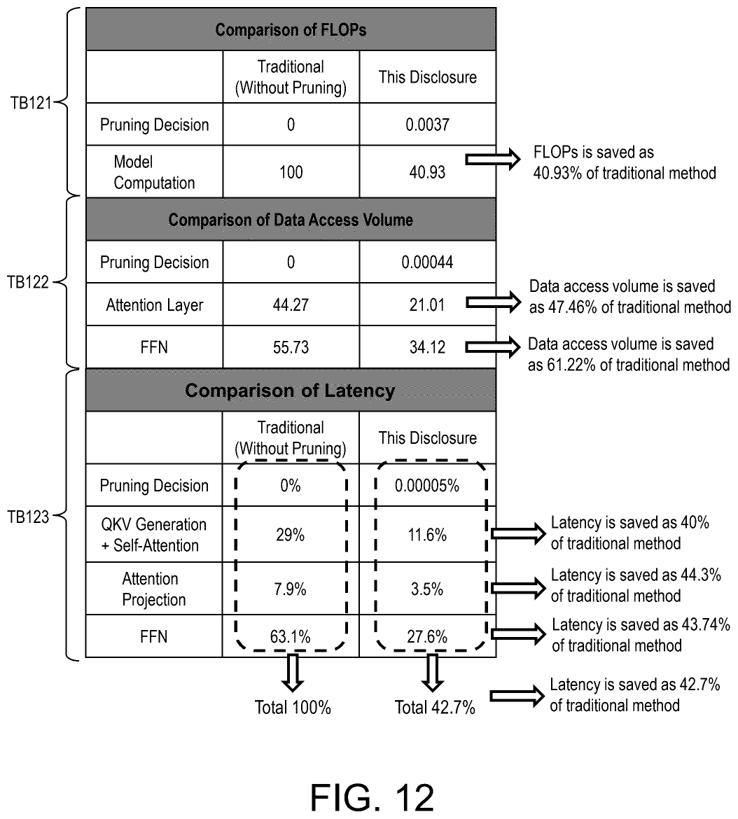

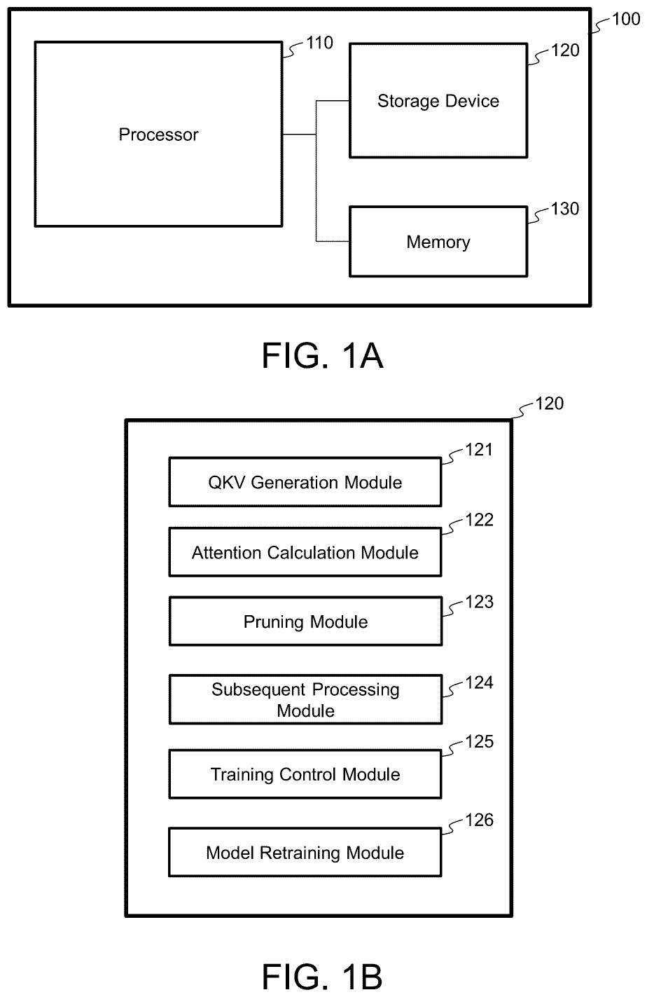

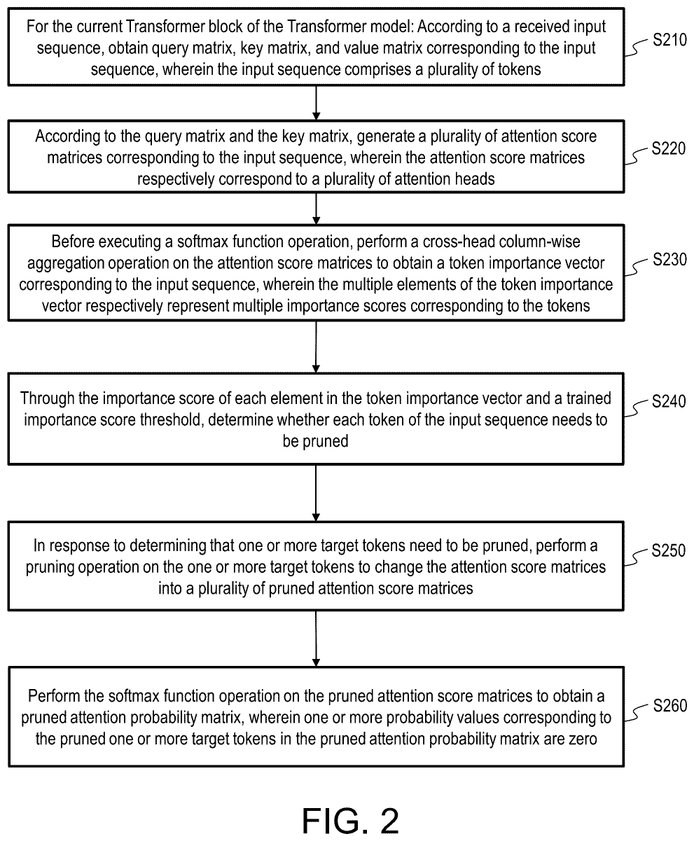

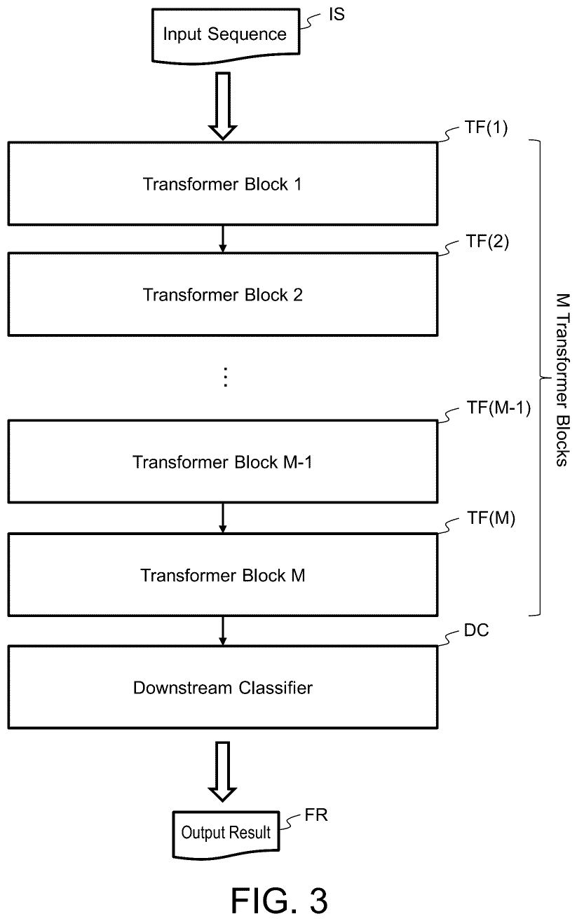

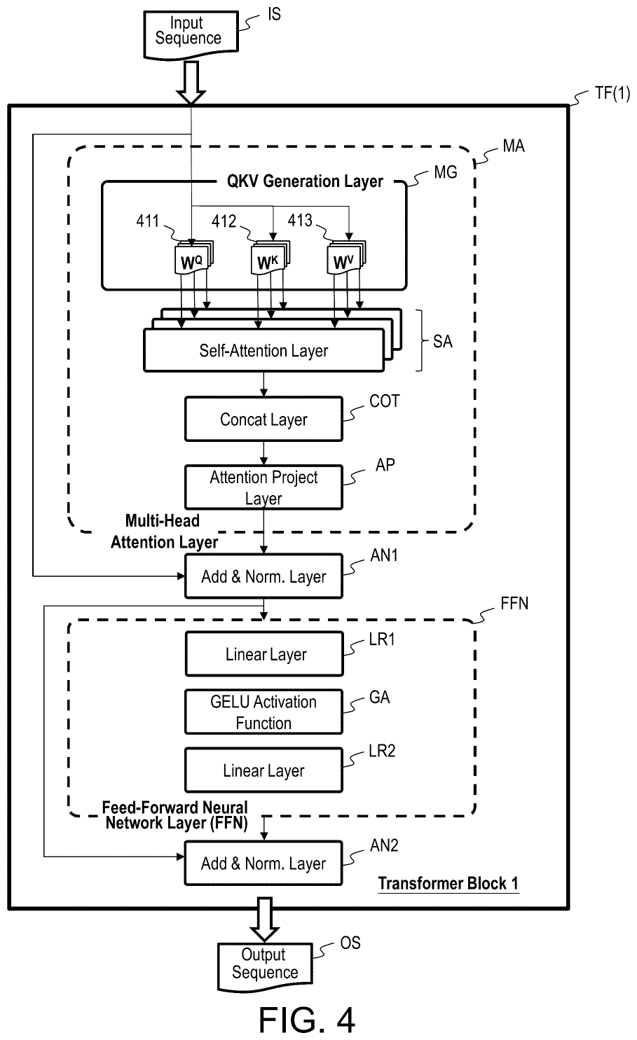

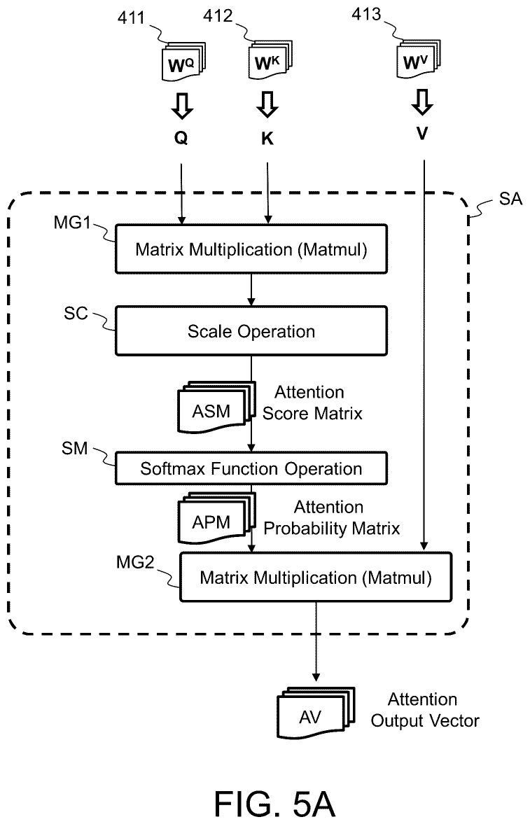

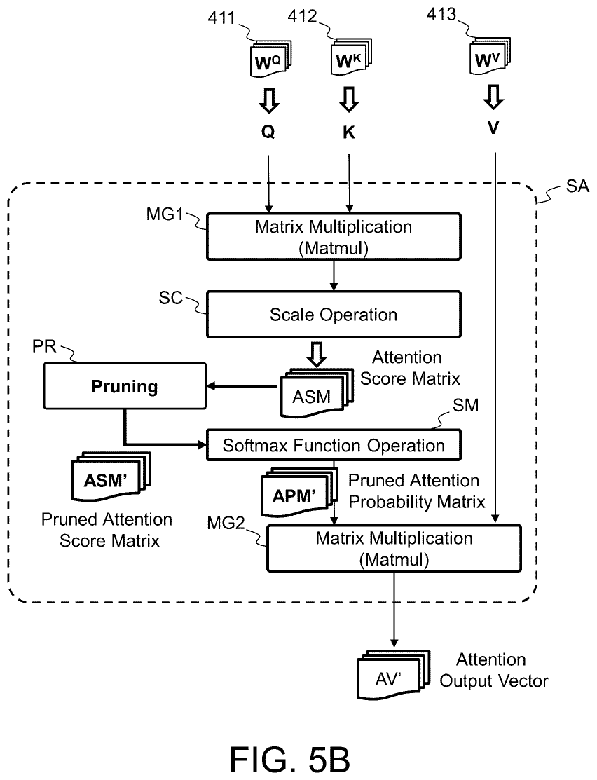

FIG. 5A is a schematic diagram of a self-attention layer of a traditional transformer model. Please refer to FIG. 5, the self-attention layer SA includes the following main components:

Multiple weight matrices: Including weight matrix W^{Q} 411, weight matrix W^{K} 412 and weight matrix W^{V} 413, used to generate query matrix Q, key matrix K and value matrix V respectively.

First matrix multiplication operation unit MG1: Receives query matrix Q and key matrix K as input, performs matrix multiplication operation (Matmul) to calculate multiple attention score matrices. Attention score matrix ASM: Stores scaled attention scores, representing the matrix of correlation degrees between different positions of tokens in the input sequence.

Scaling operation unit SC: Performs scaling operation on these attention score matrices, usually dividing by the square root of the vector dimension of the query matrix, to stabilize gradients, outputting scaled multiple attention score matrices ASM.

Softmax function operation unit SM: Performs Softmax function operation on the scaled attention score matrices ASM, converting scores into probability distributions, to obtain multiple attention probability matrices APM. Attention probability matrix APM: Stores the result of Softmax function operation, i.e., attention probability.

Second matrix multiplication operation unit MG2: Performs matrix multiplication operation (Matmul) between these attention probability matrices APM and value matrix V to produce multiple attention output vectors AV. Attention output vector AV: Stores the final output result of the self-attention layer SA.

In one embodiment, the present disclosure provides a self-attention layer architecture based on attention scores and its operation method. The following describes in detail the self-attention layer architecture of this embodiment in conjunction with FIG. 5B.

FIG. 5B is a schematic diagram of a self-attention layer of a transformer model according to an embodiment of the present disclosure. As shown in FIG. 5B, the functions of the main components included in the self-attention layer SA, such as multiple weight matrices, first matrix multiplication operation unit MG1, scaling operation unit SC, Softmax function operation unit SM, second matrix multiplication operation unit MG2 have been explained above and will not be repeated here. The following describes the components additionally provided by this disclosure compared to traditional methods:

Pruning operation unit PR (i.e., pruning module 123): The processor 110 executes the pruning module 123 to perform pruning operations on multiple attention score matrices ASM according to a predetermined pruning strategy, thereby obtaining multiple pruned attention score matrices ASM′, which are used to store attention scores after pruning operation.

After applying Softmax function operation to multiple pruned attention score matrices ASM′, multiple pruned attention probability matrices APM′ could be obtained, which store the results of Softmax function operation, i.e., pruned attention probabilities.

Then, through the second matrix multiplication operation unit MG2, matrix multiplication operation (Matmul) is performed between multiple pruned attention probability matrices APM′ and value matrix V to produce multiple attention output vectors AV′ corresponding to multiple attention heads of the input sequence, which store the final output results of the self-attention layer SA for each attention head.

In one embodiment, as shown in FIG. 4, the processor 110 connects the attention output vectors of each attention head through the concatenation layer (COT) and projects through the attention projection layer AP to obtain the final attention output vector. Then, the processor 110 applies the final attention output vector to the feed-forward neural network layer FFN and multiple add and normalization layers (such as AN1, AN2) of the current transformer block of the transformer model and subsequent transformer blocks (for example, the output of transformer block 1 will be applied to the subsequent transformer block 2).

In one embodiment, the general operation flow of the above self-attention layer is as follows: Receive query matrix Q, key matrix K and value matrix V; perform matrix multiplication operation MG1 and scaling operation SC on query matrix Q, key matrix K to obtain attention score matrix ASM; perform pruning operation on attention score matrix ASM to obtain pruned attention score matrix ASM′; perform Softmax function operation on pruned attention score matrix ASM′ to obtain pruned attention probability matrix APM′; perform matrix multiplication operation MG2 between pruned attention probability matrix APM′ and value matrix V to output attention output vector AV′.

This architecture introduces pruning operations on the basis of traditional self-attention mechanism, which can significantly reduce computational complexity while maintaining model performance. By performing pruning before Softmax operation, it can effectively reduce the amount of data for subsequent operations, thereby improving computational efficiency.

In this embodiment, the pruning method based on attention scores is mainly applied to attention score matrix ASM. Specifically, the pruning operation unit PR performs the following steps:

(1) Perform a cross-head column-wise aggregation operation on attention score matrices ASM to obtain a token importance vector, where the cross-head column-wise aggregation operation includes the following steps: Perform column-wise summation operation on matrix elements of each column of each attention score matrix (single-head column-wise summation: sum elements along the column direction of the attention score matrix corresponding to each attention head) to obtain a column-summed vector corresponding to each attention head; merge the column-summed vectors of each attention head (cross-head aggregation); perform normalization processing on the merged result; and generate the token importance vector based on the result of the normalization processing. More specifically, (1.1) Multi-head attention score matrices: Assuming there are N attention heads, the dimension of the attention score matrix ASMᵢ (i=1, 2, . . . , N) for each head is [sequence length×sequence length]. (1.2) Single-head column-wise summation: Perform column-wise summation on each ASMᵢ to obtain N vectors vᵢ, each vector with dimension [1×sequence length], the formula is vᵢ=Σ(ASMᵢ)_{column}. (1.3) Cross-head aggregation: Aggregate N vectors vᵢ, which could adopt the following methods: (a) Average aggregation: V_{avg}=(1/N)*Σ(vᵢ), i=1 to N; (b) Weighted average aggregation: v_{weighted}=Σ(wᵢ*vᵢ), i=1 to N, where wᵢ is the weight of each head, which could be preset or learnable parameters; (c) Maximum aggregation: vₘₐₓ=max (v₁, v₂, . . . , v_{N}), taking the maximum value element-wise; (d) Sum aggregation: vₛᵤₘ=Σ(vᵢ), i=1 to N. (1.4) Normalization: Perform normalization (also called standardization) on the aggregated token importance vector to ensure the stability and comparability of values. Common normalization methods include: (a) Min-Max normalization: vₙₒᵣₘ=(v−min(v))/(max(v)−min(v)); (b) Z-score normalization: vₙₒᵣₘ=(v−mean(v))/std(v). (1.5) Output token importance vector: The normalized vector is the final token importance vector, where each element corresponds to an importance score of an input token.

Compare each element in the token importance vector with a trained importance score threshold.

(3) Determine whether to prune the corresponding token based on the comparison result. For example, in one embodiment, if the target importance score of a target element in the token importance vector is less than the trained importance score threshold, it is determined that the target token corresponding to the target element in the input sequence needs to be pruned; and if a further target importance score of a further target element in the token importance vector is not less than the trained importance score threshold, it is determined that a further target token corresponding to the further target element in the input sequence does not need to be pruned.

(4) For tokens that need to be pruned, set their corresponding attention scores to zero or remove them from the matrix. For example, in one embodiment, performing the pruning operation on the one or more target tokens includes: identifying one or more target matrix elements corresponding to the one or more target tokens in each attention score matrix; and setting the one or more target matrix elements to zero or removing the one or more target matrix elements from the attention score matrix to change the attention score matrix into a pruned attention score matrix.

The following uses FIGS. 6A and 6B to illustrate examples for better understanding.

FIG. 6A is a schematic diagram of attention score matrices and token importance vector according to an embodiment of the present disclosure. As shown in FIG. 6A, the specific steps of this embodiment are as follows:

Input sequence processing: Receive input sequence IS “I love my family”.

Tokenization processing: Through tokenization steps (as shown by arrow A61), convert the input sequence IS into token sequence: “I”, “love”, “my”, “family”.

Generate attention score matrices: As shown by arrow A62, perform matrix multiplication operation MG1 and scaling operation SC on query matrix Q and key matrix K corresponding to input sequence IS to obtain multiple attention score matrices ASM. In this example, each attention score matrix ASM is a 4×4 matrix, where each element represents the attention score between corresponding token pairs (e.g., the attention score for token pair [“I” “love”] is 50).

Token importance score calculation: Use the token importance score calculation formula to perform calculations on these attention score matrices ASM to obtain token importance scores S:

$${s}^{l} ( {x}_{i} ) = \frac{1}{{N}_{h}} \frac{1}{n} {\sum }_{h = 1}^{{N}_{h}} {\sum }_{j = 1}^{n} Attention {Score}^{( h , l )} ( {x}_{i} , {x}_{j} )$$

Where: s^{l}(xᵢ) represents the importance score of the i^{th} token in the l^{th} transformer block; Nₕ is the number of attention heads; n is the sequence length; Attention Score^{(h·l)}(xᵢ, xⱼ) is the attention score of token xᵢ to xⱼ in the h^{th} head of the l^{th} transformer block.

Generate token importance vector: As shown by arrows A63, A64, A65, A66, use the token importance score calculation formula to perform cross-head column-wise aggregation operation on multiple attention score matrices ASM to obtain token importance vector TIV. In this example, the token importance vector TIV is [10, 35, 15, 50]. For example, as shown in block B61, the result of the cross-head column-wise aggregation operation for the 4th column is 50, which is recorded as the 4th element of the token importance vector TIV, representing the importance score of the 4th token “family” after cross-head column-wise aggregation operation.

FIG. 6B is a schematic diagram of pruning operation according to an embodiment of the present disclosure. In one embodiment, the present disclosure provides a method for performing pruning operations based on comparison of token importance vector and trained importance score threshold. The following explains in detail the operation process of this embodiment in conjunction with FIG. 6B, which continues the example from FIG. 6A.

First, the general operation flow of the pruning operation is as follows: Obtain token importance vector TIV; identify/obtain trained importance score threshold; compare the token importance score of each element of token importance vector TIV with the trained importance score threshold; generate binary mask BM; perform pruning operation on attention score matrix ASM through binary mask BM to obtain pruned attention score matrix ASM′.

More specifically, as shown in FIG. 6B, assume the obtained token importance vector TIV is [10, 35, 15, 50], corresponding to tokens “I”, “love”, “my” and “family” respectively, and assume the trained importance score threshold is 11. As shown by arrow A67, the pruning module 123 compares each element in token importance vector TIV with the threshold value 11: The importance score of “I” (10)<threshold value (11), needs to be pruned (corresponding to the 1st row and 1st column); the importance score of “love” (35)>threshold value (11), does not need to be pruned; the importance score of “my” (15)>threshold value (11), does not need to be pruned; the importance score of “family” (50)>threshold value (11), does not need to be pruned.

Then, the pruning module 123 generates binary mask BM based on the comparison result.

Next, as shown by arrow A68, the pruning module 123 applies binary mask BM to the original attention score matrix ASM (e.g., multiply the corresponding elements of the two matrices) to obtain the pruned attention score matrix ASM′: The row and column corresponding to “I” that should be pruned are set to 0, and the attention scores of other tokens remain unchanged.

In one embodiment, the present disclosure further provides a model training stage for training the pruning method of the transformer model based on attention scores, especially for training the importance score threshold. The following first briefly describes the training process: Initialize model parameters and learnable threshold parameters; iteratively execute model training stage; perform forward propagation and simulated pruning for each transformer block; calculate loss values and update parameters; check termination conditions and determine final thresholds.

More specifically, the implementation steps are as follows:

(1) Model initialization: Initialize parameters of the transformer model, and set a learnable threshold parameter for each transformer block.

(2) Iterative training: For each training batch, perform the following steps (a)˜(d):

(a) Input processing: Receive training sequence, which contains multiple training tokens.

(b) Forward propagation: For each transformer block TF(i) (i=1, 2, . . . , N, where N is the total number of transformer blocks), perform the following steps (b.1)-(b.3):

(b.1) Generate training attention score matrices: Calculate training attention score matrices corresponding to the training sequence based on the training sequence.

(b.2) Generate differentiable mask: Use the current threshold parameter θ and training attention score matrices to generate a differentiable mask, which is used for a simulated pruning operation. It should be noted that in one embodiment, in the model training stage, for each transformer block, the processor 110 (training control module 125) obtains a scaled training importance score corresponding to each training token based on the training importance score corresponding to each training token and a scaling function; and generates the differentiable mask based on the current threshold parameter and the scaled training importance score corresponding to each training token.

More specifically, the generation of the differentiable mask includes: For the training attention score matrices corresponding to the training sequence: Obtain a training token importance vector corresponding to the training tokens respectively, comprising a plurality of training elements; Map the training importance score of each training element through the scaling function to a scaled training importance score within the range of (0, r), where r is a hyperparameter less than 1; and Form a differentiable mask element corresponding to each training token through a sigmoid function based on the scaled training importance score of each training element and the current threshold parameter, wherein a value of the differentiable mask element is between 0 and 1.

In one embodiment, the calculation formula for the differentiable mask could be: Mask_{diff}=σ((s^{l}(xᵢ)−θ^{l})/T), where σ represents the sigmoid function (e.g., (−∞, +∞)→[0, 1]), T represents the temperature parameter; s^{l}(xᵢ) represents the importance score of the i^{th} token in the l^{th} transformer block; θ^{l} represents the learnable threshold parameter of the l^{th} transformer block. The differentiable mask includes a plurality of differentiable mask elements respectively corresponding to a plurality of elements of each training attention score matrix.

(b.3) Apply differentiable mask: Apply the differentiable mask DM(i) to the corresponding training attention score matrix ASM(i) to obtain simulated pruned attention score matrix ASM′(i): ASM′(i)=ASM(i)⊙DM(i) (⊙ represents element-wise multiplication). (2.4) Perform subsequent operations: Use the simulated pruned attention score matrix to continue executing the remaining operations of the multi-head attention mechanism, feed-forward neural network layer FFN(i) and add and normalization layer AN(i).

(c) Loss calculation: After applying the differentiable mask to the transformer blocks, obtain a plurality of threshold loss values from the transformer blocks respectively, and obtain a downstream task loss value corresponding to the transformer blocks; and obtain a total loss value based on the threshold loss values and the downstream task loss value to update the threshold parameter. More specifically, calculate threshold loss Le (i) for each transformer block: L_{θ(i)}=f(DM(i)), where f could be a function controlling the pruning degree; calculate downstream task loss Lₜₐₛₖ: calculate task-related loss based on model output and true labels; calculate total loss Lₜₒₜₐₗ: Lₜₒₜₐₗ=Lₜₐₛₖ+λ*ΣL_{θ(i)}, where λ is a balance factor.

(d) Parameter update: Use backpropagation and optimizer to update model parameters and threshold parameters θ(i).

(3) Termination check: At the end of each training epoch, check if termination conditions are met. Termination conditions could include: Reaching a preset number of training epochs; Validation set performance no longer improves; Change in threshold parameters is less than a certain threshold. More specifically, termination conditions could include one or more of: The number of times the model training stage is repeatedly executed reaches a maximum training count; For X consecutive rounds, the improvement degree of a training performance indicator on the corresponding validation dataset is less than an improvement threshold value (that is, no more significant improvement could be obtained for X consecutive iterations), where the training performance indicator includes the downstream task loss value and the threshold loss values; The difference between the updated threshold parameter and the threshold parameter before update is less than a change threshold value; and The pruning rate is greater than a pruning rate threshold value and the performance of the transformer model is greater than a performance threshold value.

(4) Final threshold determination: In response to determining that the updated threshold parameter satisfies a termination condition, set the current threshold parameter that satisfies the termination condition as the final trained importance score threshold.

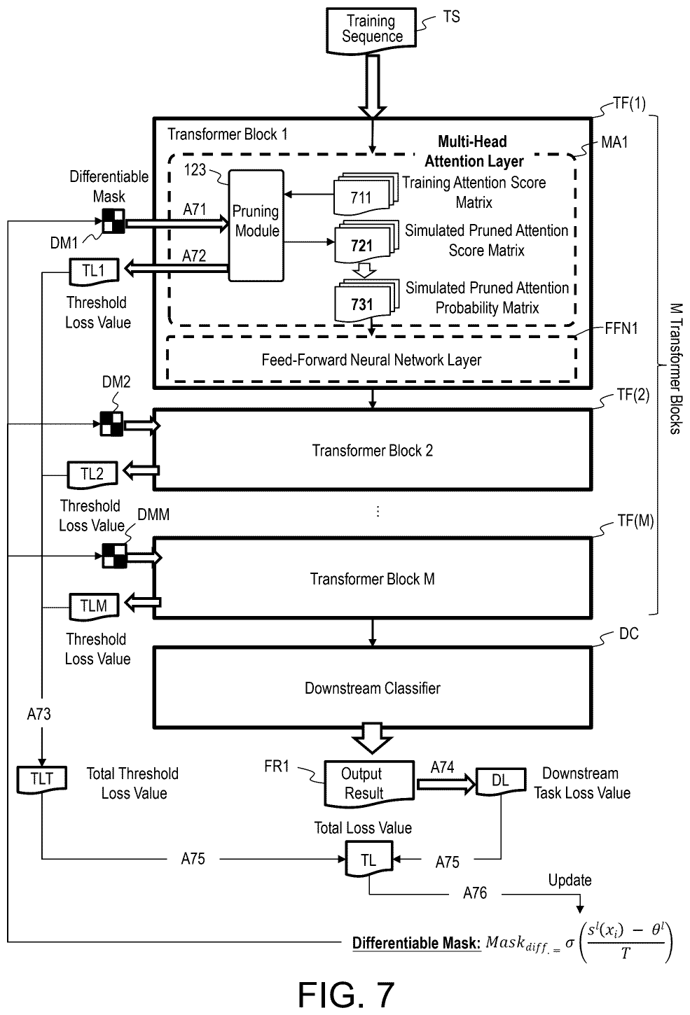

In one embodiment, the present disclosure provides a method for applying differentiable masks in the model training stage. The following describes in detail the operation process of this embodiment in conjunction with FIG. 7.

FIG. 7 is a schematic diagram illustrating the application of differentiable masks in the model training stage according to an embodiment of the present disclosure. As shown in FIG. 7, this embodiment includes the following main components and steps:

Training sequence TS: Serves as the model's input, containing multiple training tokens.

Transformer blocks: The figure shows M transformer blocks TF(1)˜TF(M), each transformer block containing multi-head attention layers and feed-forward neural network layers (e.g., transformer block 1 includes multi-head attention layer MA1 and feed-forward neural network layer FFN1).

Multi-head attention layer MA1: Taking the first transformer block TF(1) as an example, the data obtained through the multi-head attention mechanism and pruning operation of this disclosure are: Training attention score matrix 711 obtained from the training sequence; Simulated pruned attention score matrix 721 obtained by the pruning module applying differentiable mask DM1 (as shown by arrow A71) to training attention score matrix 711; Simulated pruned attention probability matrix 731 output after applying Softmax function operation to simulated pruned attention score matrix 721. As shown by arrow A72, the processor 110 will calculate the threshold loss value corresponding to each transformer block (e.g., threshold loss value TL1 corresponding to transformer block 1 TF(1)).

Differentiable mask: Apply corresponding differentiable masks DM1˜DMM to each transformer block TF(1)˜TF(M).

Downstream classifier DC: Located after the stack of transformer blocks, used to perform specific downstream tasks, and produce output result FR1 based on the output of transformer block M.

Loss value calculation: As shown by arrow A73, the processor 110 calculates the total threshold loss value TLT based on the threshold loss values TL1˜TLM corresponding to each transformer block TF(1)˜TF(M). As shown by arrow A74, the processor 110 can calculate the downstream task loss value DL based on the output result FR1. As shown by arrow A75: The processor 110 combines the total threshold loss value TLT and downstream task loss value DL to obtain the total loss value TL.

Parameter update: As shown by arrow A76, the processor 110 updates model parameters based on the total loss value TL, for example, updating the learnable threshold parameter θ^{l} of the l^{th} transformer block in the differentiable mask.

Iterative training: Repeat the above steps until predefined termination conditions are met.

In one embodiment, the present disclosure further provides a model retraining method, used for further optimizing the transformer model that has undergone pruning training after the threshold parameters θ^{l} have completed training.

When the model training stage reaches a predefined termination condition, such as validation set performance no longer improves or reaches the maximum training epochs, the processor 110 (model retraining module 126) can execute the model retraining stage. The following details the retraining process:

Input processing: Use a further training sequence TS' as input, which may contain new training data or a subset of the original training data. Input TS' into the transformer model that has applied the trained importance score threshold.

Fixed threshold value: Throughout the entire retraining process, the trained importance score threshold remains fixed and unchanged, ensuring the stability of the model structure.

For each transformer block TF(i) (i=1, 2, . . . , M), perform the following steps: (a) Generate binary mask: In the forward propagation process, use the fixed trained importance score threshold to generate corresponding binary mask BMi for each transformer block. (b) Apply binary mask: Apply the generated binary mask BMi to multiple further attention score matrices corresponding to that transformer block, obtaining multiple further pruned attention score matrices.

(c) Perform subsequent operations: Based on the further pruned attention score matrices, continue to execute the remaining steps of the transformer block, including: remaining operations of the multi-head attention mechanism, such as generating further pruned attention probability matrices; calculations of the feed-forward neural network layer FFN1; processing of multiple add and normalization layers.

Loss calculation and parameter update: (a) Use downstream classifier DC to process the final output, producing output result FR2. (b) Calculate the latest downstream task loss value DL′ based on output result FR2. (c) Update multiple weight parameters of the transformer model through backpropagation using the downstream task loss value DL′, obtaining retrained weight parameters.

Iteration process: Repeat the above steps until the retraining termination conditions are met, such as performance convergence or reaching a preset number of retraining epochs.

The advantages of retraining include, for example: (1) Fine-tuning: Allows model parameters to be fine-tuned while maintaining the pruned structure, adapting to specific tasks; (2) Performance recovery: Helps recover slight performance degradation that may be caused by pruning; (3) Structural stability: By using fixed binary masks, ensures that the model structure remains unchanged during the retraining process; (4) Computational efficiency: Maintains the computational efficiency improvement brought by pruning during the retraining process; (5) Task adaptability: Can optimize for specific downstream tasks, improving the model's performance on that task; (6) Generalization ability: Can improve the model's generalization ability by using new training data.

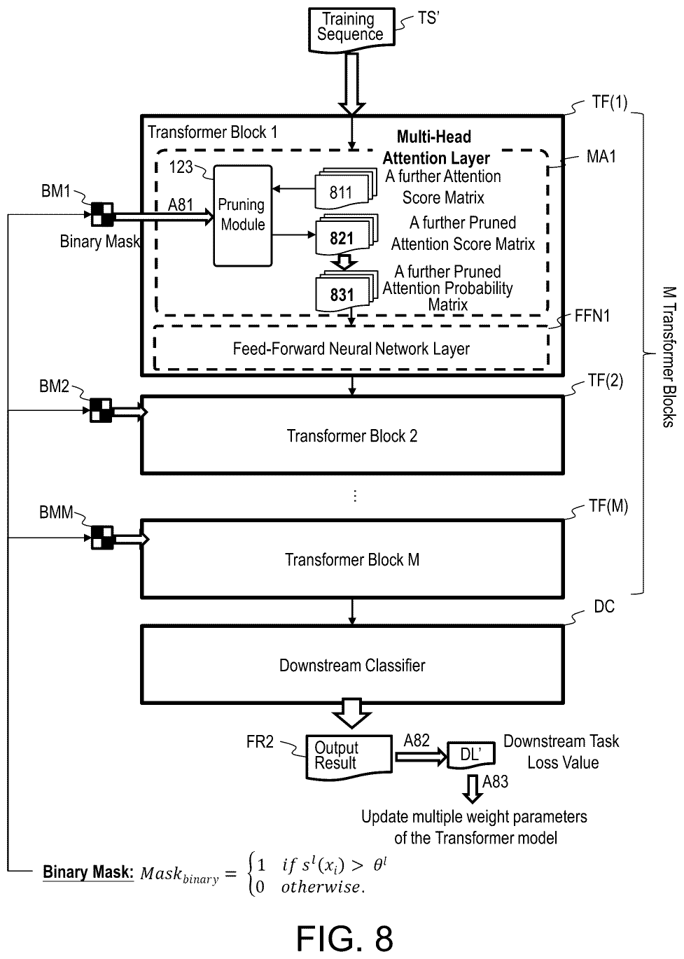

The following describes in detail the operation process of this embodiment in conjunction with FIG. 8.

FIG. 8 is a schematic diagram illustrating the application of binary masks in the model retraining stage according to an embodiment of the present disclosure. As shown in FIG. 8, this embodiment includes the following main components and steps:

A further training sequence TS′: Serves as the model's input, containing multiple training tokens. A further training sequence TS' may be different from training sequence TS.

Transformer blocks: The figure shows M transformer blocks TF(1) to TF(M), each block containing multi-head attention layers and feed-forward neural network layers (e.g., transformer block 1 includes multi-head attention layer MA1 and feed-forward neural network layer FFN1).

Multi-head attention layer MA1: Taking the first transformer block TF(1) as an example, the data obtained through the multi-head attention mechanism and pruning operation of this disclosure are: A further attention score matrix 811 obtained from a further training sequence; A further pruned attention score matrix 821 obtained by the pruning module 123 applying binary mask BM1 (as shown by arrow A81) to a further attention score matrix 811; A further pruned attention probability matrix 831 output after applying Softmax function operation to a further pruned attention score matrix 821.

Binary mask: Apply corresponding binary masks BM1˜BMM to each transformer block TF(1)˜TF(M). These binary masks are generated based on the trained importance score thresholds obtained from the previous training stage. Each transformer block applies the corresponding binary mask for pruning operations.

Downstream classifier DC: Located after the stack of transformer blocks, used to perform specific downstream tasks, and produce output result FR2 based on the output of transformer block M.

Loss value calculation: As shown by arrow A82, the processor 110 could calculate the downstream task loss value DL′ based on the output result FR2.

Parameter update: As shown by arrow A83, the processor 110 updates multiple weight parameters of the transformer model based on the downstream task loss value DL′. It should be noted that in this retraining stage, the trained importance score threshold remains fixed and unchanged.

### Calculation Formula for Binary Mask:

$${Mask}_{binary} = \{ \begin{matrix}1 & if {s}^{l} ( {x}_{i} ) > {θ}^{l} \\ 0 & otherwise\end{matrix}$$

Where s^{l}(xᵢ) represents the importance score of the i^{th} token in the l^{th} transformer block; θ^{l} represents the trained threshold parameter of the l^{th} transformer block. In the retraining stage, θ^{l} has completed training and is a fixed value, no longer updated.

Iterative retraining: Repeat the above steps, using fixed binary masks and updated weight parameters, until predefined termination conditions are met, such as model performance no longer significantly improves or reaches a preset number of retraining epochs.

Through this retraining method, the present disclosure can further optimize model parameters while maintaining the pruned structure of the model, thereby improving the model's performance on specific tasks while maintaining high computational efficiency.

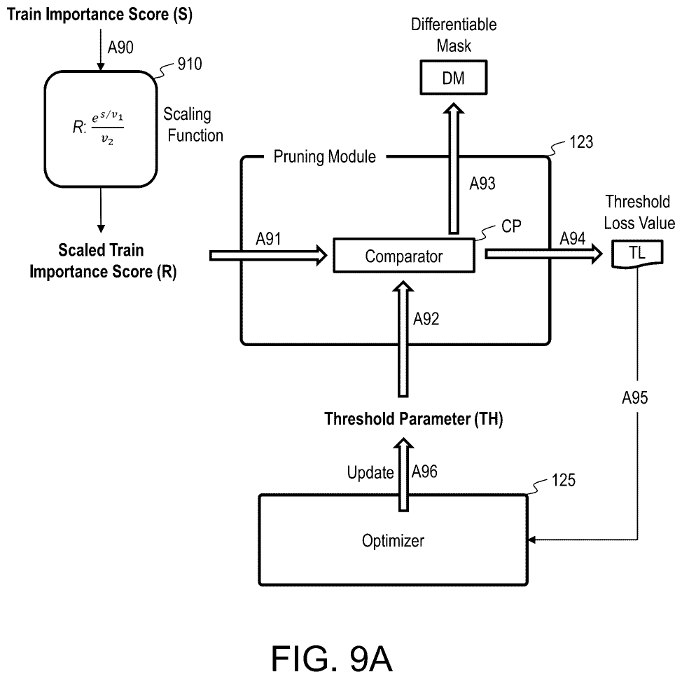

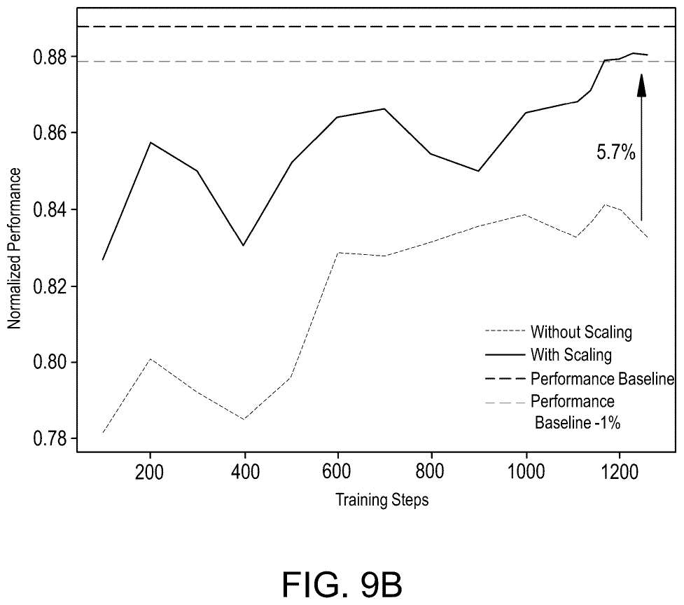

It is worth mentioning that in one embodiment, the present disclosure provides a method of applying range scaling strategy to generate differentiable masks, used to improve the pruning efficiency in the training process of the transformer. The following describes in detail the operation process of this embodiment in conjunction with FIG. 9A.

FIG. 9A is a schematic diagram illustrating the application of range scaling strategy to generate differentiable masks according to an embodiment of the present disclosure. As shown in FIG. 9A, this embodiment includes the following main components and steps:

Range scaling function unit 910: The processor 110 executes the range scaling function unit 910 to receive training importance score S as input (as shown by arrow A90), and applies the scaling function

$$\frac{{e}^{s / {v}_{1}}}{{v}_{2}}$$

to the training importance score S to obtain scaled training importance score R. Where v1 and v2 are hyperparameters, with value ranges such as {16, 32, 64, 128}. The purpose of this function is to map the input importance scores from [sₘᵢₙ, sₘₐₓ] to the range of (0, r), where r is typically less than 1.

Pruning module 123: Contains a comparator CP, used to compare the scaled training importance score R (as shown by arrow A91) and threshold parameter TH (as shown by arrow A92). The comparison result is used to generate differentiable mask DM (as shown by arrow A93).

Differentiable mask DM: Generated based on the output of comparator CP, with values between 0 and 1.

In addition, the processor 110 further calculates threshold loss value TL based on the output of pruning module 123 (as shown by arrow A94). This loss value TL is used to evaluate the effect of the current threshold parameter TH.

Optimizer 125: Receives threshold loss value TL (as shown by arrow A95), and updates threshold parameter TH based on this loss value (as shown by arrow A96). The updated threshold parameter TH could be used for subsequent iterative training stages.

The main advantages of the range scaling strategy are:

(1) Narrow down the search space for thresholds: To prune the original input S (assume 75), the threshold parameter TH (assume 0.07) needs to be updated from 0.07 to over 75; while for the scaled R (adjusted from 75 to 0.08), the threshold only needs to be slightly adjusted from 0.07 to exceed 0.08.

(2) Improve training stability: Mapping importance scores of different scales to a unified small range helps the model learn pruning strategies more stably.

(3) Increase training consistency: Makes the training process more consistent across different batches and different layers.

It is worth mentioning that, according to experimental data, after using the range scaling strategy, the performance on the STS-B dataset improved by 5.7%, while maintaining a 66% FLOPs saving rate. This indicates that this method can effectively improve the performance of transformer models after pruning.

The following describes in detail the performance comparison results in conjunction with FIG. 9B.

FIG. 9B is a schematic diagram of normalized performance comparison drawn according to an embodiment of the present disclosure. This figure shows the performance changes of the model during the training process before and after applying the range scaling strategy.

The horizontal axis in FIG. 9B represents the training steps, ranging from 0 to 1200 steps; the vertical axis represents normalized performance. The figure includes four key lines:

Lower curve: Represents the model performance without applying the range scaling strategy.

Upper curve: Represents the model performance after applying the range scaling strategy.

Upper dashed line: Represents the performance baseline, representing the best performance of the unpruned model.

Lower dashed line: Represents the performance baseline minus 1%, usually considered as the acceptable performance degradation range.

### Performance Comparison Analysis:

Initial stage (0-400 steps): The performance of both methods shows fluctuations, but the method applying the range scaling strategy has higher overall performance.

Middle stage (400-800 steps): The performance of the method without applying range scaling shows significant improvement, but is still lower than the method applying range scaling. The method applying range scaling maintains higher performance and continues to optimize.

Late stage (800-1200 steps): Both methods achieve high performance, but the method applying range scaling always maintains the lead.

At the end of training (1200 steps), the performance of the method applying range scaling is significantly higher than the method without applying this strategy.

Final performance improvement: The 5.7% marked in the figure indicates that at the end of training, the method applying the range scaling strategy improved performance by 5.7% compared to the method without applying this strategy.

Performance baseline comparison: The final performance of the method applying the range scaling strategy is close to the performance baseline (upper dashed line), and higher than the acceptable performance degradation range (lower dashed line).

Through this experiment, the advantages of the range scaling strategy can be seen:

Performance improvement: Under the same number of training steps, a 5.7% performance improvement was achieved, which is a significant improvement in large-scale language models.

Training stability: The upper curve (performance of the pruned model after applying the range scaling strategy of this disclosure) is overall smoother than the lower curve (performance of the pruned model without scaling strategy), indicating that the range scaling strategy can provide a more stable training process.

Fast convergence: After applying the range scaling strategy, the model reached a higher performance level at an earlier training stage.

Maintaining high performance: Even under pruning operations, the model is still able to maintain performance close to the baseline. In contrast, the traditional pruned model shows performance degradation when the number of training steps increases beyond 1200.

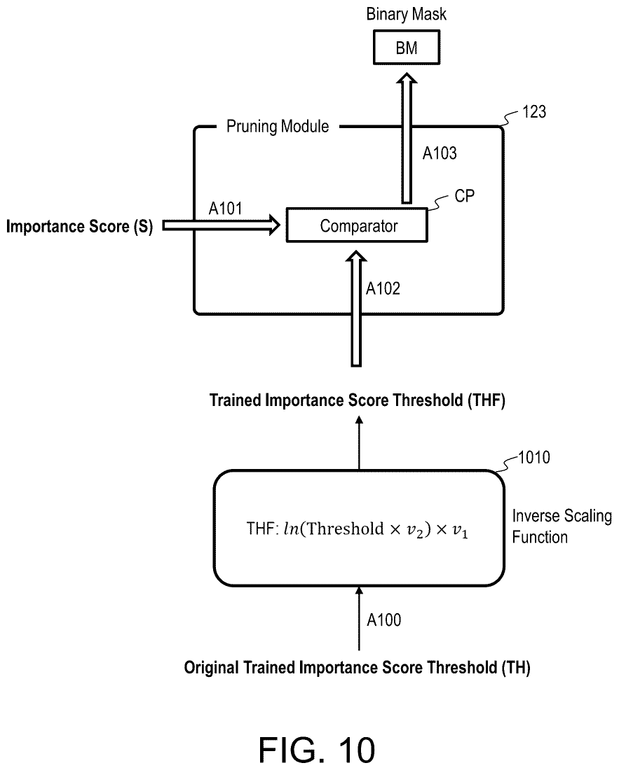

In one embodiment, the present disclosure provides a method of applying an inverse scaling function to generate binary masks, used for the inference stage or model retraining stage of the transformer model. The following describes in detail the operation process of this embodiment in conjunction with FIG. 10.

FIG. 10 is a schematic diagram illustrating the application of an inverse scaling function to generate binary masks according to an embodiment of the present disclosure. As shown in FIG. 10, this embodiment includes the following main components and steps:

Inverse scaling function unit 1010: The processor 110 executes the inverse scaling function unit 1010 to receive the original trained importance score threshold TH (with value Threshold) as input (as shown by arrow A100), and applies the inverse scaling function (also called a further scaling function) (ln(Threshold×v2)×v1) to obtain the trained importance score threshold (THF). Where v1 and v2 are hyperparameters corresponding to those used in the range scaling function during the training stage. The purpose of this inverse scaling function is to adjust the trained importance score threshold to a form suitable for direct comparison with unscaled importance scores. It should be noted that the effect of the inverse scaling function is exactly the opposite of the scaling function in FIG. 9A.

Pruning module 123: Contains a comparator CP, used to compare importance score S (as shown by arrow A101) and the inverse scaled trained importance score threshold THF (as shown by arrow A102). The comparison result is used to generate binary mask BM (as shown by arrow A103).

Binary mask BM: Generated based on the output of comparator CP, with values of 0 or 1, used for actual pruning operations. The binary mask BM is applied to pruning operations in both the inference stage and the model training stage.

The advantages of this design that directly inverse scales the original trained importance score threshold is:

Simplify inference process and improve computational efficiency: By adjusting the threshold value once instead of adjusting multiple importance scores corresponding to multiple tokens, it reduces the amount of computation.

Precision retention: Directly using original importance scores avoids potential precision loss due to repeated scaling.

It is worth mentioning that in one embodiment, the present disclosure further provides a method combining pruning operations based on attention scores and kernel fusion algorithms to further improve the computational efficiency of transformer models. The following details the implementation process of this method:

Application of kernel fusion algorithm: The method of this disclosure applies the kernel fusion algorithm in the self-attention mechanism of the transformer model, mainly including two key steps:

(a) First single kernel operation: In the process of generating attention score matrices, fuse the matrix multiplication operation between query matrix Q and key matrix K into a single operation. Specifically, when calculating QK^{T}, instead of executing matrix multiplication separately and then storing intermediate results, it is completed directly in one kernel operation.

(b) Second single kernel operation: After executing the pruning operation, fuse the softmax function operation on the pruned attention score matrices, and the matrix multiplication operation between this operation result and value matrix V, into another single kernel operation.

In one embodiment, the present disclosure provides a method combining attention score-based pruning and kernel fusion algorithms to significantly improve the computational efficiency of transformer models. This method divides the calculation process of the self-attention mechanism into external and internal loops, achieving kernel fusion through block processing and efficient use of SRAM. Overall, it includes the following steps:
(1) First Kernel Fusion, for the Fusion Calculation of Query Matrix Q and Key Matrix K, Including:

(a) Matrix partitioning: Divide query matrix Q (N×d) along the N dimension into multiple blocks; divide key matrix K (d×N) along the N dimension into multiple blocks. Where N is the sequence length, d is the dimension of the attention head.

(b) External loop processing: Iterate through the blocks of K matrix, copying each K block to SRAM.

(c) Internal loop processing: For each K block, iterate through the blocks of Q matrix; copy the current Q block to SRAM.

(d) Block calculation on SRAM: Directly calculate matrix multiplication between Q block and K block in SRAM; perform scaling operation (divide by \sqrt{d})) simultaneously.

(e) Result accumulation: Directly accumulate calculation results to temporary buffers in SRAM; avoid frequent writing back of intermediate results to HBM (High Bandwidth Memory).

(f) Output to HBM: After completing a full internal loop, output the accumulated QK^{T} result (attention score matrix) to HBM. This output matrix will be used for subsequent pruning operations and softmax calculations in the second kernel fusion.
(2) Attention Score-Based Pruning Operation, Executed Between the First Kernel Fusion and the Second Kernel Fusion, Including:

(a) Attention score matrix processing: Use the QK^{T} matrix output from the first kernel fusion, which represents the original attention scores.

(b) Token importance calculation: Perform column-wise aggregation on the QK^{T} matrix to obtain token importance vector.

(c) Pruning operation: Use the trained importance score threshold; compare each element in the token importance vector with the importance score threshold; for elements below the importance score threshold, find the corresponding tokens, and set the matrix elements corresponding to the row and column of that token in the QK^{T} matrix to zero.

(d) Generate pruned attention score matrix: The result of the pruning operation is the pruned attention score matrix, which is still in the form of QK^{T}, but with some elements set to zero.

(e) Prepare for second kernel fusion: This pruned attention score matrix will serve as the input for the second kernel fusion, used for subsequent softmax and multiplication operations with value matrix V.
(3) Second Kernel Fusion, which is the Fusion Calculation of Softmax and Value Matrix V, Including:

(a) Pruned matrix preparation: Use the pruned attention score matrix, which may be smaller than the original attention score matrix.

(b) External loop processing: Iterate through blocks of the pruned attention score matrix.

(c) Internal loop processing: For each attention score block, iterate through blocks of value matrix V (N×d); copy the current V block to SRAM.

(d) Fusion calculation on SRAM: Perform local Softmax calculation on the attention score block in SRAM; immediately perform matrix multiplication with V block on the Softmax result.

(e) Result accumulation: Directly accumulate calculation results to output buffers in SRAM; avoid storing complete intermediate Softmax results.

(f) Result output: After completing a full internal loop, output the accumulated results to HBM.

### Advantages of the Kernel Fusion Algorithm:

Reduce memory access: By combining multiple operations, it significantly reduces the number of accesses to high bandwidth memory (such as GPU's HBM).

Improve computational efficiency: Reduces the storage and reading of intermediate results, completing more calculations directly in fast SRAM.

Enhance parallelism: Fusion operations allow better utilization of the parallel computing capabilities of modern processors.

It is worth mentioning that the method of this disclosure can effectively combine attention score-based pruning and kernel fusion techniques without causing performance degradation like traditional methods, mainly for the following reasons:

Attention score basis: This disclosure uses attention scores rather than attention probabilities for pruning decisions. This key difference allows this method to complete pruning operations before softmax calculations, thus perfectly aligning with kernel fusion techniques.

Avoid synchronization issues: Traditional methods using attention probabilities need to wait for the complete softmax calculation to finish, which leads to synchronization issues and additional buffer overhead. The method of this disclosure effectively avoids this problem by pruning before softmax.

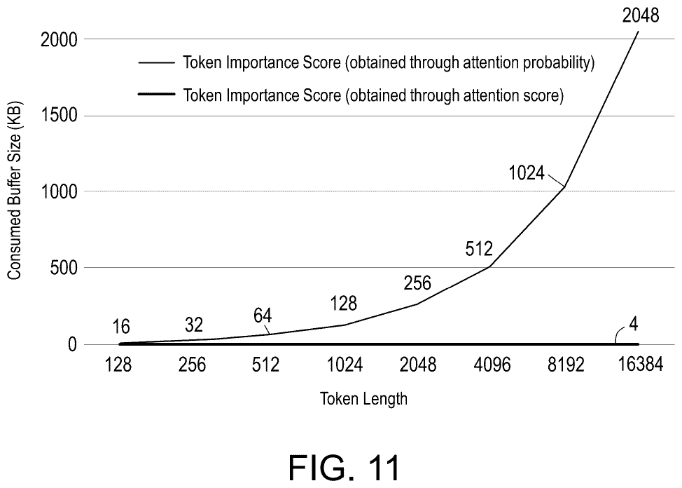

Buffer usage optimization (see FIG. 11): The pruning method based on attention scores in this disclosure maintains relatively stable and small buffer size requirements under different token lengths, while the method based on attention probabilities increases dramatically with token length.

Computational efficiency improvement: According to experimental results, compared to FlashAttention-2 (a kernel fusion method), the method of this disclosure additionally reduces 58.70% of data access and 60.74% of computational load (FLOPs), but only introduces a 0.0005% FLOPs overhead.

Through this innovative combination, this disclosure achieves full utilization of the performance improvements brought by kernel fusion technology while maintaining high-efficiency pruning effects. This method not only solves the technical challenges faced by traditional methods when combining pruning and kernel fusion, but also further improves the model's performance and resource utilization efficiency in practical applications.

FIG. 11 is a schematic diagram comparing the consumed buffer sizes corresponding to different pruning methods according to an embodiment of the present disclosure. This figure shows the buffer usage of two methods based on attention probability and attention score under different token lengths.

Please refer to FIG. 11, the horizontal axis in FIG. 11 represents token length, ranging from 128 to 16384; the vertical axis represents the required buffer size, in units of KB (kilobytes). The figure includes two curves:

Upper curve: Represents the buffer size corresponding to different token lengths for the token importance score calculation method based on attention probability.

Lower curve: Represents the buffer size corresponding to different token lengths for the token importance score calculation method based on attention score proposed by this disclosure.

Performance of the method based on attention probability (upper curve): As the token length increases, the required buffer size grows exponentially, where it only consumes 16 KB buffer when the token length is 128; when the token length increases to 16384, the required buffer surges to 2048 KB.

Performance of the method based on attention score proposed by this disclosure (lower curve): As the token length increases, the required buffer size remains relatively stable. Throughout the entire token length range (128 to 16384), the consumed buffer size consistently remains around 4 KB.

In other words, using the method based on attention scores provided by this disclosure, compared to the traditional method based on attention probability, after applying kernel fusion, has the following advantages:

Buffer usage efficiency: At a token length of 16384, the method of this disclosure only needs a 4 KB buffer, while the method based on attention probability requires 2048 KB. The buffer usage of this disclosure's method is only about 0.2% of the traditional method.

Scalability: As token length increases, the buffer demand of this disclosure's method remains almost constant, showing excellent scalability. The traditional method faces severe memory pressure when processing long sequences.

Computational efficiency: Smaller buffer requirements mean fewer memory accesses, potentially leading to higher computational efficiency.

Hardware-friendly: The stable ultra-low buffer requirement makes the method of this disclosure more suitable for operation on memory-constrained hardware.

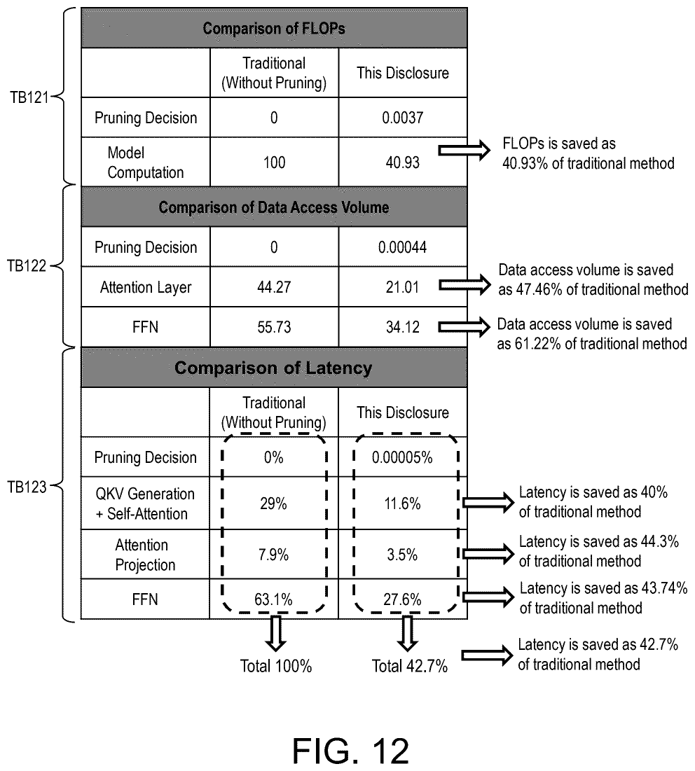

FIG. 12 is a schematic diagram comparing FLOPs, data access volume, and latency between traditional methods and the attention mechanism adjustment method provided by this disclosure. Please refer to FIG. 12, which shows the performance improvements of this disclosure in three main aspects compared to traditional practices, namely the comparison of FLOPs (floating point operations) (see table TB121), comparison of data access volume (see table TB122), comparison of latency (see table TB123).

First, as shown in table TB121, in terms of FLOPs, the method of this disclosure reduces the model's computational FLOPs to 40.93% of the traditional method, i.e., saving 59.07% of computational load. It is worth noting that the method of this disclosure only increases FLOPs overhead by 0.0037% when executing pruning judgments, slightly increased compared to the traditional method's 0% (not using pruning operations), but this tiny increase can be exchanged for a significant overall reduction in computational load.

Secondly, as shown in table TB122, in terms of data access volume, the method of this disclosure achieves significant reductions in data access volume on three main components:

(1) The data access volume of the attention layer is reduced from 44.27% to 21.01%, down to only 47.46% of the data access volume of the traditional approach.

(2) The data access volume of the feed-forward network (FFN) is reduced from 55.73% to 34.12%, down to only 61.22% of the data access volume of the traditional approach.

(3) The data access volume for pruning judgment is only 0.00044%, which can be almost ignored, showing that the method of this disclosure can achieve very large effects in exchange for a relatively small sacrifice in data access volume.

Finally, as shown in table TB123, in terms of latency, the method of this disclosure achieves significant improvements at each stage:

The latency of QKV generation and self-attention calculation is reduced from 29% to 11.6%, i.e., down to only 40% of the latency of the traditional approach.

The latency of attention projection is reduced from 7.9% to 3.5%, i.e., down to only 44.3% of the latency of the traditional approach.

The latency of FFN is significantly reduced from 63.1% to 27.6%, i.e., down to only 43.74% of the latency of the traditional approach.

The latency introduced by pruning judgment is only 0.00005%, which can be almost ignored.

Overall, the method of this disclosure reduces the total latency from 100% to 42.7%, achieving a 57.3% latency reduction.

From the above experimental results, it can be seen that: The core advantage of the method of this disclosure lies in balancing computational efficiency and model performance. By using attention scores rather than traditional attention probabilities for token importance assessment, it not only reduces computational complexity but also reduces data access requirements. As it is particularly suitable for combination with kernel fusion technology, it can further improve computational efficiency and avoid excessive buffer requirements.

Based on the above, the attention mechanism adjustment method and computing device provided by one or more embodiments of this disclosure, by using attention score matrices rather than traditional attention probability matrices to calculate token importance scores, avoid the buffer overhead problem that may occur when combined with kernel fusion technology. This improvement enables this disclosure to be more compatible with advanced computational optimization techniques, further enhancing the overall performance of the model. By comparing importance scores with trained importance score thresholds that have been optimized through training, this method can more precisely identify and prune unimportant tokens, thereby significantly reducing computational complexity and memory usage while maintaining model accuracy. Furthermore, the pruning operation of this disclosure directly acts on the attention score matrices, and applies the softmax function in subsequent steps to obtain the pruned attention weight matrices. This method not only reduces invalid operations in subsequent calculations, but can also effectively improve the computational efficiency and inference speed of transformer models. Especially when processing long sequence inputs, the advantages of this method are more obvious, greatly reducing computational resource consumption, making large language models (LLMs) more suitable for deployment and application in resource-constrained environments.

It will be apparent to those skilled in the art that various modifications and variations can be made to the disclosed embodiments without departing from the scope or spirit of the present disclosure. In view of the foregoing, it is intended that the present disclosure covers modifications and variations provided that they fall within the scope of the following claims and their equivalents.

What is claimed is:

1. An attention mechanism adjustment method based on attention scores, adapted for a transformer model, the method comprising:
for a current transformer block of the transformer model:
obtaining a query matrix, a key matrix and a value matrix corresponding to a received input sequence, wherein the input sequence comprises a plurality of tokens;
generating a plurality of attention score matrices corresponding to the input sequence based on the query matrix and the key matrix, wherein the attention score matrices respectively correspond to a plurality of attention heads;
before executing a softmax function operation, performing a cross-head column-wise aggregation operation on the attention score matrices to obtain a token importance vector corresponding to the input sequence, wherein a plurality of elements of the token importance vector respectively represent a plurality of importance scores corresponding to the tokens;
determining whether each token of the input sequence needs to be pruned through the importance score of each element in the token importance vector and a trained importance score threshold;
in response to determining that one or more target tokens need to be pruned, changing the attention score matrices into a plurality of pruned attention score matrices by performing a pruning operation on the one or more target tokens; and
performing the softmax function operation on the pruned attention score matrices to obtain a pruned attention probability matrix, wherein one or more probability values corresponding to the pruned one or more target tokens in the pruned attention probability matrix are zero, so as to optimize the attention mechanism of the transformer model, reduce invalid operations in subsequent calculations, and thereby improve calculation efficiency and inference speed of the transformer model.

2. The attention mechanism adjustment method as claimed in claim 1, wherein step of determining whether each token of the input sequence needs to be pruned comprises:
determining that a target token corresponding to a target element in the input sequence needs to be pruned if a target importance score of the target element in the token importance vector is less than the trained importance score threshold; and
determining that a further target token corresponding to a further target element in the input sequence does not need to be pruned if a further target importance score of the further target element in the token importance vector is not less than the trained importance score threshold.

3. The attention mechanism adjustment method as claimed in claim 1, wherein performing the pruning operation on the one or more target tokens comprises:
identifying one or more target matrix elements corresponding to the one or more target tokens in each attention score matrix; and
setting the one or more target matrix elements to zero or removing the one or more target matrix elements from the attention score matrix, so as to change the attention score matrix into a pruned attention score matrix.

4. The attention mechanism adjustment method as claimed in claim 1, further comprising:
obtaining an attention output vector corresponding to the input sequence based on the pruned attention probability matrix and the value matrix;
concatenating and projecting the attention output vector of each attention head to obtain a final attention output vector; and
applying the final attention output vector to a feed-forward neural network layer and a plurality of add and normalization layers of the current transformer block of the transformer model and subsequent transformer blocks.

5. The attention mechanism adjustment method as claimed in claim 1, the method further comprising:
iteratively executing a model training stage, wherein the model training stage comprises:
for each transformer block among a plurality of transformer blocks, performing the following steps:
obtaining a learnable threshold parameter, and generating a plurality of training attention score matrices corresponding to a training sequence based on the training sequence, wherein the training sequence comprises a plurality of training tokens;
in a forward propagation process, using current threshold parameter to generate a differentiable mask, wherein the differentiable mask being used for a simulated pruning operation;
applying the differentiable mask to the training attention score matrices to obtain a plurality of simulated pruned attention score matrices, wherein the differentiable mask comprises a plurality of differentiable mask elements respectively corresponding to a plurality of elements of each training attention score matrix;
based on the simulated pruned attention score matrices, continuing to perform subsequent steps of the transformer block, including: remaining operations of multi-head attention mechanism, feed-forward neural network layer and a plurality of add and normalization layers;
after applying the differentiable mask to the transformer blocks, obtaining a plurality of threshold loss values from the transformer blocks respectively, and obtaining a downstream task loss value corresponding to the transformer blocks;
obtaining a total loss value based on the threshold loss values and the downstream task loss value to update the threshold parameter; and
in response to determining that the updated threshold parameter satisfies a termination condition, setting the threshold parameter that satisfies the termination condition as a final trained importance score threshold.

6. The attention mechanism adjustment method as claimed in claim 5, wherein in the model training stage, for each transformer block, the method further comprises:
obtaining a scaled training importance score corresponding to each training token based on a training importance score corresponding to each training token and a scaling function; and
generating the differentiable mask based on the current threshold parameter and the scaled training importance score corresponding to each training token.

7. The attention mechanism adjustment method as claimed in claim 6, wherein generating the differentiable mask comprises:
for the training attention score matrices corresponding to the training sequence:
obtaining a training token importance vector corresponding to the training tokens respectively, comprising a plurality of training elements;
mapping, through the scaling function, the training importance score of each training element to a scaled training importance score within a range of (0, r), wherein r is a hyperparameter less than 1; and
forming a differentiable mask element corresponding to each training token through a sigmoid function based on the scaled training importance score of each training element and the current threshold parameter, wherein a value of the differentiable mask element is between 0 and 1.

8. The attention mechanism adjustment method as claimed in claim 5, wherein the termination condition comprises one or more of the following:
the number of times the model training stage is repeatedly executed reaches a maximum training count;
for X consecutive rounds, an improvement degree of a training performance indicator on a corresponding validation dataset is less than an improvement threshold value, wherein the training performance indicator comprises the downstream task loss value and the threshold loss values;
a difference between the updated threshold parameter and the threshold parameter before update is less than a change threshold value; and
a pruning rate is greater than a pruning rate threshold value and a performance of the transformer model is greater than a performance threshold value.

9. The attention mechanism adjustment method as claimed in claim 8, after the termination condition is satisfied, the method further comprises executing a model retraining stage, wherein the model retraining stage comprises:
using a further training sequence as input to the transformer model applying the trained importance score threshold, wherein the trained importance score threshold remains fixed;
for each transformer block:
in a forward propagation process, using the trained importance score threshold to generate a binary mask, the binary mask being used for a further pruning operation;
applying the binary mask to a plurality of further attention score matrices corresponding to the further training sequence to obtain a plurality of further pruned attention score matrices;
based on the further pruned attention score matrices, continuing to perform subsequent steps of the transformer block, including: remaining operations of multi-head attention mechanism, feed-forward neural network layer and a plurality of add and normalization layers; and
updating a plurality of weight parameters of the transformer model based on a latest obtained downstream task loss value to obtain a plurality of retrained weight parameters of the transformer model.

10. The attention mechanism adjustment method as claimed in claim 1, wherein step of determining whether the corresponding token needs to be pruned through comparing the importance score of each element in the token importance vector with the trained importance score threshold comprises:
using the trained importance score threshold to generate a binary mask, the binary mask being used for the pruning operation, wherein generating the binary mask comprises:
in response to determining that the importance score of a first target element of each token importance vector is greater than the trained importance score threshold, setting a value corresponding to the first target element in the binary mask to 1; and
in response to determining that the importance score of a second target element of each token importance vector is not greater than the trained importance score threshold, setting a value corresponding to the second target element in the binary mask to 0,
wherein performing the pruning operation comprises:
applying the binary mask to each attention score matrix to obtain the pruned attention score matrix.

11. The attention mechanism adjustment method as claimed in claim 10, the method further comprising:
using a further scaling function to adjust an original trained importance score threshold output from a model training stage to obtain the trained importance score threshold used to generate the binary mask,
wherein the importance score used to generate the binary mask is not adjusted through a scaling function.

12. The attention mechanism adjustment method as claimed in claim 1, wherein the method further comprises applying a kernel fusion algorithm, the kernel fusion algorithm comprising:
during the process of generating the attention score matrices corresponding to the input sequence, fusing the matrix multiplication operation between the query matrix and the key matrix into a first single kernel operation; and
after completing the pruning operation, fusing the softmax function operation performed on the pruned attention score matrices and the matrix multiplication operation between the calculation result corresponding to the softmax function operation and the value matrix into a second single kernel operation.

13. The attention mechanism adjustment method as claimed in claim 1, wherein the cross-head column-wise aggregation operation comprises the following steps:
performing a column-wise summation operation on matrix elements of each column of each attention score matrix to obtain a column-summed vector corresponding to each attention head;
merging the column-summed vectors of each attention head;
performing normalization processing on the merged result; and
generating the token importance vector based on the result of the normalization processing.

14. A computing device, adapted for executing a transformer model that adjusts attention mechanism based on attention scores, the computing device comprising:
a processor;
a memory, coupled to the processor; and
a storage device, coupled to the processor, the storage device storing a plurality of program code modules, wherein the processor is configured to execute the program code modules to:
for a current transformer block of the transformer model:
obtain, via a query-key-value (QKV) generation module, a query matrix, a key matrix and a value matrix corresponding to a received input sequence, wherein the input sequence comprises a plurality of tokens;
generate, via an attention calculation module, a plurality of attention score matrices corresponding to the input sequence based on the query matrix and the key matrix, wherein the attention score matrices respectively correspond to a plurality of attention heads;
before executing a softmax function operation, perform, via a pruning module, a cross-head column-wise aggregation operation on the attention score matrices to obtain a token importance vector corresponding to the input sequence, wherein a plurality of elements of the token importance vector respectively represent a plurality of importance scores corresponding to the tokens;
determine, via the pruning module, whether each token of the input sequence needs to be pruned through the importance score of each element in the token importance vector and a trained importance score threshold;
in response to determining that one or more target tokens need to be pruned, change, via the pruning module, the attention score matrices into a plurality of pruned attention score matrices by performing a pruning operation on the one or more target tokens; and
perform the softmax function operation on the pruned attention score matrices to obtain a pruned attention probability matrix, wherein one or more probability values corresponding to the pruned one or more target tokens in the pruned attention probability matrix are zero, so as to optimize the attention mechanism of the transformer model, reduce invalid operations in subsequent calculations, and thereby improve calculation efficiency and inference speed of the transformer model.

15. The computing device as claimed in claim 14, wherein the pruning module is configured to:
determine that a target token corresponding to a target element in the input sequence needs to be pruned if a target importance score of the target element in the token importance vector is less than the trained importance score threshold; and
determine that a further target token corresponding to a further target element in the input sequence does not need to be pruned if a further target importance score of the further target element in the token importance vector is not less than the trained importance score threshold.

16. The computing device as claimed in claim 14, wherein the pruning module is configured to:
identify one or more target matrix elements corresponding to the one or more target tokens in each attention score matrix; and
set the one or more target matrix elements to zero or remove the one or more target matrix elements from the attention score matrix to change the attention score matrix into a pruned attention score matrix.

17. The computing device as claimed in claim 14, wherein the processor is further configured to execute the program code modules to cause the computing device to:
via a subsequent processing module:
obtain an attention output vector corresponding to the input sequence based on the pruned attention probability matrix and the value matrix;
concatenate and project the attention output vector of each attention head to obtain a final attention output vector; and
apply the final attention output vector to a feed-forward neural network layer and a plurality of add and normalization layers of the current transformer block of the transformer model and subsequent transformer blocks.

18. The computing device as claimed in claim 14, wherein the processor is further configured to execute the program code modules to cause the computing device to:
iteratively execute a model training stage via a training control module, wherein the model training stage comprises:
for each transformer block among a plurality of transformer blocks, perform the following steps:
obtain a learnable threshold parameter, and generate a plurality of training attention score matrices corresponding to a training sequence based on the training sequence, wherein the training sequence comprises a plurality of training tokens;
in a forward propagation process, use the current threshold parameter to generate a differentiable mask, the differentiable mask being used for a simulated pruning operation;
apply the differentiable mask to the training attention score matrices to obtain a plurality of simulated pruned attention score matrices, wherein the differentiable mask comprises a plurality of differentiable mask elements respectively corresponding to a plurality of elements of each training attention score matrix;
via the subsequent processing module, based on the simulated pruned attention score matrices, continue to perform subsequent steps of the transformer block, including: remaining operations of multi-head attention mechanism, feed-forward neural network layer and a plurality of add and normalization layers; and
after applying the differentiable mask to the transformer blocks, obtain a plurality of threshold loss values from the transformer blocks respectively, and obtain a downstream task loss value corresponding to the transformer blocks;
obtain a total loss value based on the threshold loss values and the downstream task loss value to update the threshold parameter; and
in response to determining that the updated threshold parameter satisfies a termination condition, set, via the training control module, the threshold parameter that satisfies the termination condition as a final trained importance score threshold.

19. The computing device as claimed in claim 18, wherein the processor is further configured to execute the program code modules to cause the computing device in the model training stage, for each transformer block:
obtain a scaled training importance score corresponding to each training token based on a training importance score corresponding to each training token and a scaling function; and
generate the differentiable mask based on the current threshold parameter and the scaled training importance score corresponding to each training token.

20. The computing device as claimed in claim 19, wherein the training control module is configured to:
for the training attention score matrices corresponding to the training sequence:
obtain a training token importance vector corresponding to the training tokens respectively, comprising a plurality of training elements;
map, through the scaling function, the training importance score of each training element to a scaled training importance score within a range of (0, r), wherein r is a hyperparameter less than 1; and
form a differentiable mask element corresponding to each training token through a sigmoid function based on the scaled training importance score of each training element and the current threshold parameter, wherein a value of the differentiable mask element is between 0 and 1.

21. The computing device as claimed in claim 18, wherein the termination condition comprises one or more of the following:
the number of times the model training stage is repeatedly executed reaches a maximum training count;
for X consecutive rounds, an improvement degree of a training performance indicator on a corresponding validation dataset is less than an improvement threshold value, wherein the training performance indicator comprises the downstream task loss value and the threshold loss values;
a difference between the updated threshold parameter and the threshold parameter before update is less than a change threshold value; and
a pruning rate is greater than a pruning rate threshold value and a performance of the transformer model is greater than a performance threshold value.

22. The computing device as claimed in claim 21, wherein the processor is further configured to execute the program code modules to cause the computing device to execute a model retraining stage via a model retraining module after the termination condition is satisfied, wherein the model retraining stage comprises:
using a further training sequence as input to the transformer model applying the trained importance score threshold, wherein the trained importance score threshold remains fixed;
for each transformer block:
in a forward propagation process, generate, via a binary mask generation module, a binary mask using the trained importance score threshold, the binary mask being used for a further pruning operation;
apply, via the pruning module, the binary mask to a plurality of further attention score matrices corresponding to the further training sequence to obtain a plurality of further pruned attention score matrices;
via the subsequent processing module, based on the further pruned attention score matrices, continue to perform subsequent steps of the transformer block, including: remaining operations of multi-head attention mechanism, feed-forward neural network layer and a plurality of add and normalization layers; and
update a plurality of weight parameters of the transformer model based on a latest obtained downstream task loss value to obtain a plurality of retrained weight parameters of the transformer model.

23. The computing device as claimed in claim 14, wherein the pruning module is configured to:
use the trained importance score threshold to generate a binary mask, the binary mask being used for the pruning operation, wherein generating the binary mask comprises:
in response to determining that the importance score of a first target element of each token importance vector is greater than the trained importance score threshold, setting a value corresponding to the first target element in the binary mask to 1;
in response to determining that the importance score of a second target element of each token importance vector is not greater than the trained importance score threshold, setting a value corresponding to the second target element in the binary mask to 0,
wherein the pruning module is configured to:
apply the binary mask to each attention score matrix to obtain the pruned attention score matrix.

24. The computing device as claimed in claim 23, wherein the processor is further configured to execute the program code modules to cause the computing device to:
use a further scaling function to adjust an original trained importance score threshold output from a model training stage to obtain the trained importance score threshold used to generate the binary mask,
wherein the importance score used to generate the binary mask is not adjusted through a scaling function.

25. The computing device as claimed in claim 14, wherein the processor is further configured to execute the program code modules to cause the computing device to apply a kernel fusion algorithm, the kernel fusion algorithm comprising:
during the process of generating the attention score matrices corresponding to the input sequence, fusing the matrix multiplication operation between the query matrix and the key matrix into a first single kernel operation; and
after completing the pruning operation, fusing the softmax function operation performed on the pruned attention score matrices and the matrix multiplication operation between the calculation result corresponding to the softmax function operation and the value matrix into a second single kernel operation.

26. The computing device as claimed in claim 14, wherein the cross-head column-wise aggregation operation comprises the following steps:
performing a column-wise summation operation on matrix elements of each column of each attention score matrix to obtain a column-summed vector corresponding to each attention head;
merging the column-summed vectors of each attention head;
performing normalization processing on the merged result; and
generating the token importance vector based on the result of the normalization processing.
